(19) United States
(12) Patent Application Publication
(10) Pub. No.: US 2023/0212718 A1
(43) Pub. Date: Jul. 6, 2023

(54) HYDROGEN STORAGE ALLOYS

(71) Applicant: NewSouth Innovations Pty Ltd, Kensington (AU)

(72) Inventors: Kondo-Francois AGUEY-ZINSOU, Waterloo (AU); Wei LIU, Riverwood (AU); Poojan Jitendra MODI, Kogarah (AU)

(21) Appl. No.: 17/633,007

(22) PCT Filed: Aug. 5, 2020
(86) PCT No.: PCT/AU2020/050804

§ 371 Date: Feb. 4, 2022

(30) Foreign Application Priority Data
Aug. 5, 2019 (AU) 2019902796

(51) Int. Cl. C22C 30/00; C22C 1/02; C22C 22/00; C22F 1/02; C22F 1/16

(52) U.S. Cl. CPC C22C 30/00; C22C 1/02; C22C 22/00; C22F 1/02; C22F 1/16; C22C 2202/04

(57) ABSTRACT

The present disclosure relates to TiMn-based or TiCrMn-based hydrogen storage alloys capable of absorbing and releasing hydrogen. In preferred embodiments the disclosure relates to TiMn-based or TiCrMn-based hydrogen storage alloys comprising ferrovanadium (VFe).

The present application is a national phase application of PCT/AU2020/050804, filed Aug. 5, 2020, which claims priority from Australian provisional patent application No 2019902796 titled ‘Hydrogen Storage Alloys’ filed 5 Aug. 2019, the entire contents of which are hereby incorporated by cross-reference.

### TECHNICAL FIELD

The present invention relates to hydrogen storage alloys capable of absorbing and releasing hydrogen. More particularly, the present invention relates to hydrogen storage alloys capable of absorbing and releasing hydrogen at moderate temperature and pressure.

### BACKGROUND

Hydrogen is an appealing proposition as a renewable energy source and has potential as a cost-effective alternative to chemical batteries, remote electricity generation, household heating and portable power generation. Hydrogen is a very reactive gas and has the highest density of energy per unit weight of any chemical fuel, but it has a very low volumetric energy density.

Commercially viable hydrogen storage systems ideally require a hydrogen storage material that has a high hydrogen storage capacity, a suitable desorption temperature/pressure profile, good kinetics, good reversibility, resistance to poisoning or oxidation by contaminants, relatively low cost, or a combination of any two or more of these properties. In particular, a low desorption temperature is desirable to reduce the amount of energy required to release the hydrogen, good reversibility enables the hydrogen storage material to be capable of repeated absorption-desorption cycles without significant loss of hydrogen storage capabilities, and good kinetics enable hydrogen to be absorbed or desorbed in suitable timeframes.

Certain metals and alloys are known for the reversible storage of hydrogen. Solid-phase storage of hydrogen in a metal or alloy system works by absorbing hydrogen through the formation of a metal hydride under a specific temperature/pressure or electrochemical conditions, and releasing hydrogen by changing these conditions. When bound to metal hydrides in the form of alkali-, alkaline earth-, transition- and rare-earth metals, hydrogen can be safely stored. Metal hydride systems offer the advantage of high-density hydrogen-storage through the insertion of hydrogen atoms into the metal crystal lattice.

Various intermetallic compounds, denoted as AxBy (where A and B typically represent elements forming hydrides and non-hydriding elements, respectively) are known. However, such alloys suffer from a range of problems or drawbacks, including high hysteresis (Peq_abs>>Peq_des) which hinders the complete release of stored hydrogen, high sensitivity to oxidation, sensitivity to impurities, pyrophoricity, low hydrogen storage capacity, high hydrogen desorption plateau pressure, inability to absorb and release hydrogen to meet specific application requirements, including the ability to plug into hydrogen units producing hydrogen including electrolysers, steam reformers, etc., and hydrogen consuming units including fuel cells, and high cost, among others.

The composition of metal hydride alloys influences how well the alloy can bond, store and release hydrogen. To date, no metal hydride alloy has been developed that has hydrogen absorption/desorption profiles and other properties suitable for use in electrolysers and fuel cells, including on a commercial scale.

There is a need for alternative hydrogen storage alloys. There is also a need for hydrogen storage alloys that may ameliorate or substantially overcome one or more disadvantages or drawbacks of alloys known in the art.

### SUMMARY

The present invention broadly relates to TiMn- and TiCrMn-based hydrogen storage alloys. More particularly, the present invention relates to TiMn- and TiCrMn-based hydrogen storage alloys which comprise ferrovanadium (VFe) and optionally one or more additional modifier elements.

In a first aspect the invention relates to a hydrogen storage alloy having the formula TiₓZr_{y}Mn_{z}Crᵤ(VFe)ᵥM_{w}, wherein
M is selected from one or more of V, Fe, Cu, Co, Mo, Al, La, Ni, Ce and Ho;
x is 0.6-1.1;
y is 0-0.4;
z is 0.9-1.6;
u is 0-1;
v is 0.01-0.6;
w is 0-0.4.

In preferred embodiments, v is 0.02-0.6. For example, in one or more embodiments v is 0.02, 0.05, 0.1, 0.15, 0.2, 0.25, 0.3, 0.35, 0.4, 0.45, 0.50, 0.55 or 0.60.

In preferred embodiments x is 0.9-1.1.

In preferred embodiments y is 0.1-0.4.

In preferred embodiments z is 1.0-1.6. For example, in one or more embodiments z is 1.0, 1.05, 1.1, 1.15, 1.2, 1.25, 1.3, 1.35, 1.4, 1.45, 1.5, 1.55 or 1.6.

In one or more embodiments u is 0, 0.1, 0.15, 0.18, 0.2, 0.3, 0.4, 0.5, 0.6, 0.75, 0.8 or 0.95.

In one or more embodiments w is 0, 0.02, 0.05, 0.06, 0.07, 0.08, 0.09, 0.1, 0.2 or 0.4.

In one or more embodiments the alloy has a hydrogen storage capacity of at least 1.5 wt % H₂, or at least 1.6 wt % H₂, or at least 1.7 wt % H₂, or at least 1.8 wt % H₂, or at least 1.9 wt % H₂, or at least 2 wt % H₂, or least 2.1 wt % H₂, or least 2.2 wt % H₂, or least 2.3 wt % H₂, or least 2.4 wt % H₂, or least 2.5 wt % H₂, or at least 2.6 wt % H₂, or at least 2.7 wt. % H₂, or at least 2.8 wt. % H₂, or at least 2.9 wt. % H₂, or least 3 wt % H₂, or least 3.25 wt % H₂, or least 3.5 wt % H₂, or least 3.75 wt % H₂, or at least 4 wt. % H₂ at 30 bar.

In one or more embodiments the alloy has a hydrogen storage capacity of at least 4.5 wt % H₂, or least 5 wt % H₂, or least 6 wt % H₂ at 100 bar.

In one or more embodiments the alloy is adapted to desorb at least 65%, or at least 75%, at least 80%, or at least 85%, or at least 90%, or at least 95% of the stored hydrogen at 30 bar.

In one or more embodiments the alloy is capable of a rate of uptake and release of hydrogen of at least about 0.5 g H₂/min, or at least about 0.75 g H₂/min, or at least about 1.0 g H₂/min, or at least about 1.25 g H₂/min, or at least about 1.4 g H₂/min.

In preferred embodiments the hydrogen storage alloy has a C14 Laves phase.

In another aspect the present invention relates to the use of an alloy according to the first aspect of the invention, for the storage and release of hydrogen.

### Definitions

Throughout this specification, unless the context clearly requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term ‘consisting essentially of’ means that the listed features are the essential features, but other non-essential or non-functional features may be present that do not materially alter the way the invention works.

Throughout this specification, the term ‘consisting of’ means consisting only of.

Any discussion of documents, acts, materials, devices, articles or the like which has been included in the present specification is solely for the purpose of providing a context for the present technology. It is not to be taken as an admission that any or all of these matters form part of the prior art base or were common general knowledge in the field relevant to the present technology as it existed before the priority date of each claim of this specification.

Unless the context requires otherwise or specifically stated to the contrary, integers, steps, or elements of the technology recited herein as singular integers, steps or elements clearly encompass both singular and plural forms of the recited integers, steps or elements.

In the context of the present specification the terms ‘a’ and ‘an’ are used to refer to one or more than one (i.e., at least one) of the grammatical object of the article. By way of example, reference to ‘an element’ or ‘an integer’ means one element or integer, or more than one element or integer.

Where a range of values or integers is given in this specification, the recited range is intended to include any single value or integer within that range, including the values or integers demarcating the range endpoints. Accordingly, and by way of illustration, in this specification a reference to the range ‘from 1 to 6’ includes 1, 2, 3, 4, 5 and 6, and any value in between, e.g., 2.1, 3.4, 4.6, 5.3 and so on. Similarly, a reference to the range from ‘0.1 to 0.6’ includes 0.1, 0.2, 0.3, 0.4, 0.5 and 0.6 and any value in between, e.g., 0.15, 0.22, 0.38, 0.47, 0.59, and so on.

In the context of the present specification the term ‘about’ means that reference to a number or value is not to be taken as an absolute number or value, but includes margins of variation above or below the number or value in line with what a skilled person would understand according to the art, including within typical margins of error or instrument limitation. In other words, use of the term ‘about’ is to be understood to refer to an approximation that a person or skilled in the art would consider to be equivalent to a recited number or value in the context of achieving the same function or result.

In the context of this specification references to ‘tuning’ a hydrogen storage alloy refers to adjusting, modifying or refining a characteristic or feature of the hydrogen alloy, such as the composition or structure of the hydrogen alloy, and/or the temperature at which the alloy is annealed, to achieve a desired property profile. In this context, the ‘property profile’ refers to a hydrogen storage property profile and includes, but is not limited to, hydrogen storage capacity, hydrogen uptake/release pressure, rate of hydrogen uptake or release, plateau pressure, plateau slope and hysteresis.

Those skilled in the art will appreciate that the technology described herein is susceptible to variations and modifications other than those specifically described. It is to be understood that the technology includes all such variations and modifications. For the avoidance of doubt, the technology also includes all of the steps, features, and compounds referred to or indicated in this specification, individually or collectively, and any and all combinations of any two or more of said steps, features and compounds. That is, various discrete or preferred embodiments of the invention have been disclosed, however it should be understood that this disclosure implicitly encompasses all scientifically feasible combinations of embodiments disclosed herein, even if those combinations have not been expressly disclosed.

In order that the present technology may be more clearly understood, preferred embodiments will be described with reference to the following figures and examples.

### Abbreviations

Peq Equilibrium plateau pressure
Peq_abs Absorption plateau pressure
Peq_des Desorption plateau pressure
PCT Pressure-Composition Temperature

### BRIEF DESCRIPTION OF THE DRAWINGS

FIG. 1 illustrates the modification of alloy compositions in accordance with the present invention and the versatile process for tuning hydrogen storage properties to suit a particular end use, such as for example, electrolyser/fuel cell application.

FIG. 2 shows (A) hydrogen absorption rate, (B) hydrogen desorption rate, and (C) H₂ release/uptake plateau pressure for the base alloy Ti_{1.1}CrMn.

FIG. 3 shows hydrogen absorption rate, hydrogen desorption rate, and H₂ release/uptake pressure for the alloy compositions Ti_{1.1}CrMn(V_{0.85}Fe_{0.15})_{0.2} (LHS) and Ti_{1.1}CrMn(V_{0.85}Fe_{0.15})_{0.4} (RHS).

FIG. 4 shows (A) hydrogen absorption rate, (B) hydrogen desorption rate, and (C) H₂ release/uptake pressure for the alloy composition Ti_{1.1}CrMn(V_{0.85}Fe_{0.15})_{0.3}.

FIG. 5 shows hydrogen absorption rate, hydrogen desorption rate, and H₂ release/uptake pressure for alloy compositions Ti_{1.1}CrMn(V_{0.85}Fe_{0.15})_{0.4}Zr_{0.2} (LHS) and Ti_{1.1}CrMn(V_{0.85}Fe_{0.15})_{0.4}Zr_{0.4} (RHS). The addition of zirconium tunes the plateau pressure properties, e.g., decreases the hydrogen release/uptake pressure.

FIG. 6 shows (A) hydrogen absorption rate, (B) hydrogen desorption rate, and (C) H₂ release/uptake pressure for TiMn_{1.5} alloy (non-annealed).

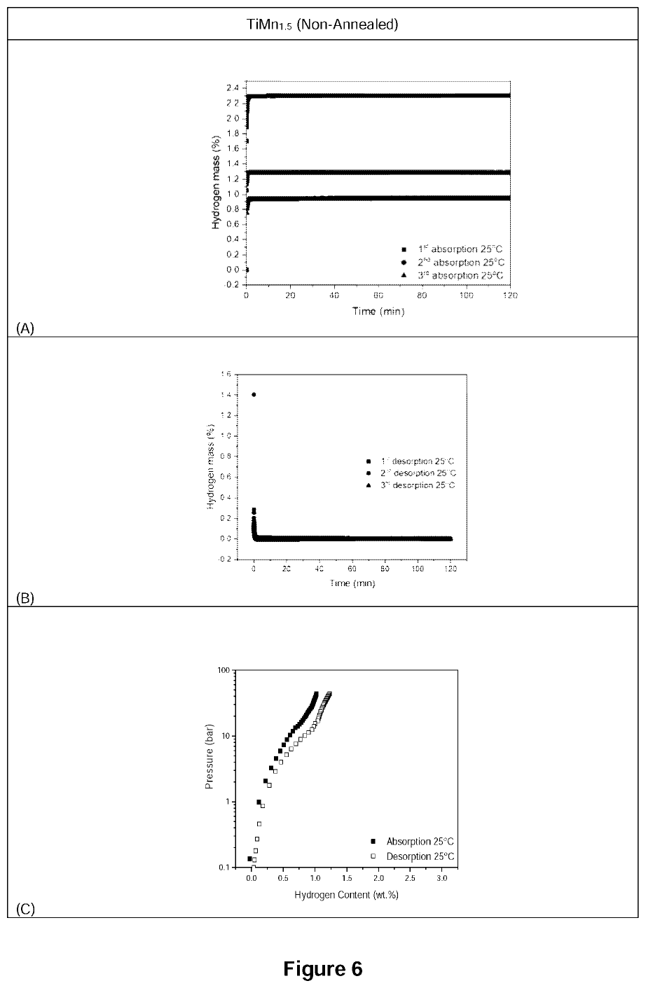

FIG. 7 shows (A) hydrogen absorption rate, (B) hydrogen desorption rate, and (C) H₂ release/uptake pressure for TiMn_{1.5} alloy (annealed). Annealing reduces plateau slope.

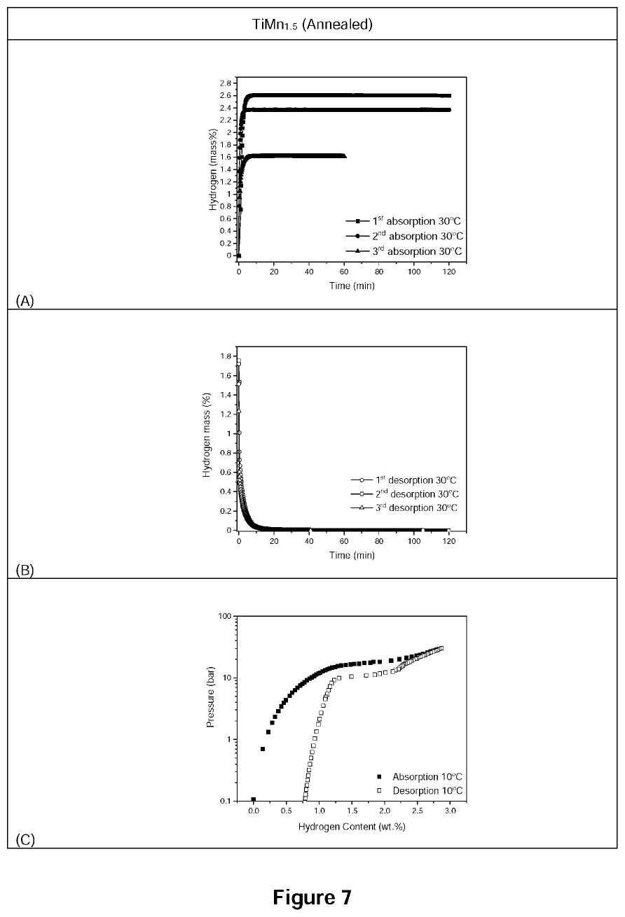

FIG. 8 shows H₂ release/uptake pressure for TiMn_{1.5}(V_{0.85}Fe_{0.15})_{0.4} alloy (non-annealed). The addition of ferrovanadium increases hydrogen storage capacity.

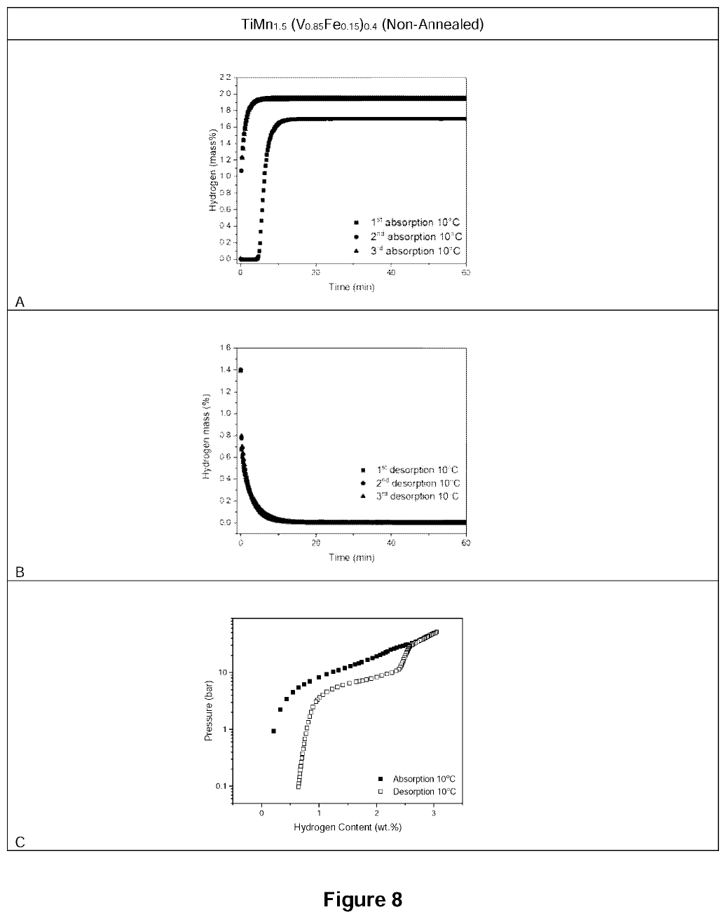

FIG. 9 shows an example of hydrogen uptake (30 bar) and release (0.5 bar) at room temperature of the alloy Ti_{0.9}Zr_{0.15}Mn_{1.1}Cr_{0.6}Co_{0.1}(V_{0.85}Fe_{0.15})_{0.3} showing full uptake and full hydrogen release at >95% efficiency and extremely fast rate of hydrogen sorption (<2 min to reach full capacity).

FIG. 10 illustrates how an alloy formulation may be tuned in accordance with the present invention to meet varied temperature-pressure work ranges.

FIG. 11 shows a representative sample of an alloy according to the present invention being handled in air without pyrophoricity.

FIG. 12 shows the activation of a representative alloy according to the present invention, Ti_{0.9}Zr_{0.15}Mn_{1.05}Cr_{0.5}Co_{0.1}Fe_{0.15}(V_{0.85}Fe_{0.15})_{0.3}, at room temperature under 30 bar hydrogen pressure with approximately 2 minutes incubation time.

FIG. 13 demonstrates the effect of ferrovanadium (V_{0.85}Fe_{0.15}) in modifying the hydrogen storage capacity of representative TiCrMn-based alloys. The addition of ferrovanadium increases hydrogen storage capacity.

FIG. 14 demonstrates the effect of Fe on the equilibrium plateau pressure of TiCrMn-based alloys.

FIG. 15 shows the effect of partial substitution of Ti with Zr in controlling the plateau slope of TiCrMn-based alloy: (a) Ti_{1.1}CrMn(V_{0.85}Fe_{0.15})_{0.4}Fe_{0.1}; (b) TiZr_{0.1} CrMn(V_{0.85}Fe_{0.15})_{0.4}Fe_{0.1}. This is an illustration of addition and fine tuning to control the slope of plateau pressure.

FIG. 16 shows the effect of Mn/Cr ratio in controlling the hysteresis of the TiCrMn-based alloy.

FIG. 17 shows Ti_{0.9}Zr_{0.15}Mn_{1.2}Cr_{0.5}Co_{0.1}(V_{0.85}Fe_{0.15})_{0.3} has high storage capacity and a plateau pressure which is suitable for hydrogen storage coupled with electrolyser and fuel cell.

FIG. 18 shows an XRD pattern of Ti_{0.9}Zr_{0.15}Mn_{1.2}Cr_{0.5}Co_{0.1}(V_{0.85}Fe_{0.15})_{0.3} showing the C14 Laves phase of the alloy.

FIG. 19 shows the effect of ferrovanadium (V_{0.85}Fe_{0.15}) in increasing the hydrogen storage capacity of TiMn-based alloys.

FIG. 20 shows the effect of the annealing process in controlling the plateau slope of TiMn-based alloy. Annealing treatment at a temperature higher than higher than 900° C., and in particular above 1000° C., was found to be particularly effective for reducing the plateau slope of TiMn-based alloys.

FIG. 21 shows the effect of the annealing process in controlling the hysteresis of TiMn-based alloys. The annealing process decreased the absorption plateau, while increasing the desorption plateau pressure, leading to a reduced hysteresis.

FIG. 22 shows TiMn_{1.5}(V_{0.85}Fe_{0.15})_{0.45} has high storage capacity and a plateau pressure suitable to be used for hydrogen storage coupled with electrolyser and fuel cell.

FIG. 24 shows an XRD pattern of TiMn_{1.5}(V_{0.85}Fe_{0.15})_{0.5} annealed at 1100° C. showing the C14 Laves phase of the alloy.

FIG. 24 shows Cycling of the alloy Ti_{0.9}Zr_{0.15}Mn_{1.2}Cr_{0.5}Co_{0.1}(V_{0.85}Fe_{0.15})_{0.3} showing no degradation after 150 cycles. This is a demonstration of long life cycling showing that the alloy is >90% efficient, does not lose its storage capacity and fully releases/absorbs hydrogen.

FIG. 25 illustrates an ideal case of hydrogen storage on Pressure-Composition-Temperature.

### DETAILED DESCRIPTION OF EMBODIMENTS

The present invention broadly relates to hydrogen storage alloys for the reversible storage of hydrogen, preferably at ambient temperature and moderate pressure. As such the hydrogen storage alloys of the present invention may have a practical application in conjunction with electrolysers and/or fuel cells. Other aspects of the invention disclosed herein are directed to approaches for making and handling hydrogen storage metal alloys, including improving stability in air. Further aspects of the invention disclosed herein are directed to methods for modifying or tuning the properties of hydrogen storage alloys.

Embodiments of the invention disclosed herein relate to TiMn-based alloys or TiCrMn-based alloys which may be modified in accordance with the present invention by the addition of VFe and optionally one or more additional modifier elements (M) to adjust or tune one or more properties of the alloy material.

In one aspect the present invention relates to a hydrogen storage alloy having the formula TiₓZr_{y}Mn_{z}Crᵤ(VFe)ᵥM_{w}, wherein
M is a modifier element selected from one or more of V, Fe, Cu, Co, Mo, Al, La, Ni, Ce and Ho;
x is 0.6-1.1;
y is 0-0.4;
z is 0.9-1.6;
u is 0-1;
v is 0.01-0.6;
w is 0-0.4

Integers x, y, z, u, v and w refer to mole number in the alloy formula. Integer w represents the total proportion (mole number) of modifier element M, which may be comprised of a single element or a combination of two or more elements. When M comprises a combination of two or more elements, each element may be present in any amount or ratio such that the total does not exceed the value w. In a preferred embodiment, w is 0.01-0.4.

Another aspect disclosed herein relates to a method for making a TiMn- or TiCrMn-based hydrogen storage alloy having a property profile, the method comprising modifying the composition of the alloy to achieve the property profile, wherein modifying the composition of the alloy comprises at least one of:
(a) including VFe and optionally one or more additional modifier elements (M) in the alloy;
(b) modifying the ratio of two or more elements in the alloy; and
(c) annealing the alloy at an annealing temperature of between 900° C. to 1200° C.

In the present specification, an alloy composition may be written to indicate the mole number of component elements as well as a particular annealing temperature. For example, in the formula TiMn_{1.4}V_{0.1}(V_{0.85}Fe_{0.15})_{0.4}-1100 the suffix ‘-1100’ indicates that the alloy was annealed at a temperature of 1100° C.

In one or more embodiments, the property profile comprises at least one property selected from increased H₂ storage capacity, increased H₂ uptake/release pressure, decreased H₂ uptake/release pressure, reduced plateau slope, reduced hysteresis, and substantially flat equilibrium plateau pressure.

Another aspect disclosed herein relates to a method for tuning the properties of a hydrogen storage alloy, wherein the hydrogen storage alloy is a TiMn-based alloy or TiCrMn-based alloy, the method comprising one or more of:
(a) including VFe and optionally one or more additional modifier elements (M) in the hydrogen storage alloy, wherein M is selected from any one or more of Fe, Cu, Co, Ti, Zr, Al, Cr, La, Ni, Ce, Ho, V, Mo;
(b) modifying the ratio of two or more component elements in the alloy;
(c) annealing the alloy using an appropriate annealing treatment.

In preferred embodiments the annealing treatment comprises annealing at a temperature of about 800° C. to about 1200° C., preferably about 850° C. to about 1150° C., more preferably about 900° C. to about 1100° C.

An embodiment disclosed herein relates to a hydrogen storage alloy comprising an elemental composition range of: Ti (18-40%), Mn (25-60%), Cr (0-25%), M (0.1-35%), wherein M is a modifier element selected from one or more of VFe, Fe, Cu, Co, Ti, Zr, Al, Cr, La, Ni, Ce, Ho, Mo and V. In preferred embodiments, the alloy comprises an elemental composition range of: Ti (18-40 wt %), Mn (25-60 wt %), Cr (0-25 wt %), M (0.5-35 wt %).

In preferred embodiments, the modifier element M is selected from any one or more of ferrovanadium (VFe), Fe, Cu, Co, Ti, Zr, Al, Cr, La, Ce, Mo, Ho. In particularly preferred embodiments, the modifier element M is selected from VFe, Fe and Zr, or any combination thereof.

In preferred embodiments the alloy comprises VFe. In preferred embodiments, the alloy comprises VFe and optionally one or more additional modifier elements. In preferred embodiments, the alloy comprises VFe and one or more additional modifier elements selected from Zr, V, Fe, Co, Mo.

In preferred embodiments, the ferrovanadium has the elemental composition range Fe(₁₅₋₆₅)V(₃₅₋₈₅), e.g., Fe(₁₅₋₅₀)V(₅₀₋₈₅). In preferred embodiments, the ferrovanadium is (V_{0.85}Fe_{0.15}) or (V_{0.5}Fe_{0.5}). In particularly preferred embodiments, the ferrovanadium is (V_{0.85}Fe_{0.15}).

In preferred embodiments, the modifier element M comprises, or consists essentially of, VFe (0-10 wt %), Fe (0-10 wt %) and Zr (10-15 wt %), preferably VFe (1-10 wt %), Fe (0-10 wt %) and Zr (10-15 wt %).

In other preferred embodiments, the modifier element M comprises, or consists essentially of, VFe (0-50 wt %), Fe (0-10 wt %) and Zr (10-15 wt %), preferably VFe (1-50 wt %), Fe (0-10 wt %) and Zr (10-15 wt %).

Inclusion of one or more modifier elements in the alloy enables the properties of the hydrogen storage alloy to be modified or tuned. For example, in one or more embodiments, the inclusion of ferrovanadium (VFe) increases hydrogen storage capacity. In one or more embodiments, inclusion of any one or more of Fe, Cu, Co and Ti increases hydrogen uptake/release pressure. In one or more embodiments, inclusion of any one of more of Zr, Al, Cr, La, Ni, Ce, Ho, Mo and V decreases hydrogen uptake/release pressure. In one or more embodiments a reduction in plateau slope may be achieved by partial substitution of Ti with Zr, or partial substitution of Mn with Co. In alternative embodiments a reduction in plateau slope may be achieved by selecting an appropriate annealing treatment of the alloy. In other embodiments, hysteresis may be reduced by the addition of one or more modifier elements (M) to the alloy, e.g., addition of V or partial substitution of Ti with Zr, or by modifying the ratio of elements within the alloy, e.g., modifying the Mn/Cr ratio.

In preferred embodiments, the metal alloys have a hydrogen storage capacity of at least 2 wt % H₂, or least 2.5 wt % H₂, or at least 3 wt. %, or at least 3.5 wt. %, or at least 4 wt. %, or at least 4.5 wt. %, or at least 5 wt. %, or at least 5.5 wt. %, or at least 6 wt. %. In alternative embodiments, the metal alloys have a hydrogen storage capacity of at least 2 wt % H₂, or least 2.5 wt % H₂, or at least 3 wt. %, or at least 3.5 wt. %, or at least 4 wt. % at 30 bar. In other embodiments, the metal alloys have a hydrogen storage capacity of at least 5 wt. %, or at least 5.5 wt. %, or at least 6 wt. % at 100 bar.

In one or more preferred embodiments, the metal alloys of the present invention satisfy the requirement of 30 bar hydrogen input pressure and at least 3 bar hydrogen output pressure, suitable for fuel cells.

In one or more preferred embodiments, the present invention relates to hydrogen storage alloys capable of absorbing and releasing hydrogen at moderate temperature and pressure. Advantageously, in one or more preferred embodiments metal alloys in accordance with the present invention may be capable of rapid uptake (e.g., 30 bar) and release (e.g., 0.5 bar) of hydrogen, and in preferred embodiments this may be achieved at moderate temperature (e.g., room temperature). In one or more preferred embodiments, alloys of the present invention may achieve charging/discharging rates of at least about 0.5 g H₂/min, or at least about 0.75 g H₂/min, or at least about 1.0 g H₂/min, or at least about 1.25 g H₂/min, or at least about 1.4 g H₂/min, which provides a significant advantage over known alloys.

A further advantage of one or more preferred embodiments of the present invention is the provision of a cost effective alloy for bulk storage of hydrogen, where the raw starting materials/elements are abundant. As an additional advantage, alloys according to one or more preferred embodiments of the present invention may be capable of absorbing and releasing high amounts of hydrogen, under moderate conditions.

Metal alloys in accordance with the present invention are based on a TiMn₂ or TiCr₂ alloy, which may be modified in accordance with the present invention by the addition of one or more modifier elements (M) to adjust or tune the properties of the alloy material. In preferred embodiments, the invention relates to TiMn-based alloys (e.g., TiMn_{1.5} based alloys) or TiCrMn-based alloys (e.g., Ti_{1.1}CrMn based alloys) which may be modified in accordance with the present invention by the addition of one or more modifier elements (M) to adjust or tune the properties of the alloy material.

In one aspect the invention relates to a hydrogen storage alloy comprising an elemental composition range of: Ti (18-40%), Mn (25 60%), Cr (0-25%), M (0.5-35%), wherein M is a modifier element selected from one or more of VFe, Fe, Cu, Co, Ti, Zr, Al, Cr, La, Ni, Ce, Ho and V. Thus, in various embodiments the metal hydride hydrogen storage alloy may have the elemental composition TiMn-M or TiMnCr-M.

In preferred embodiments, the modifier element M is selected from any one or more of ferrovanadium (VFe), Fe, Cu, Co, Ti, Zr, Al, Cr, La, Ce, Ho. In particularly preferred embodiments, the modifier element M is selected from VFe, Fe and Zr, or any combination thereof. In especially preferred embodiments, the modifier element M is VFe. In other preferred embodiments the alloy comprises VFe and optionally one or more additional modifier elements.

In preferred embodiments, the modifier element M comprises VFe (0-10 wt %), Fe (0-10 wt %) and Zr (10-15 wt %), more preferably VFe (0.5-10 wt %), Fe (0-10 wt %) and Zr (10-15 wt %).

Inclusion of the modifier element enables the properties of the hydrogen storage alloy to be modified or tuned. For example, in one or more embodiments, the inclusion of ferrovanadium (VFe) increases hydrogen storage capacity. In one or more embodiments, inclusion of any one or more of Fe, Cu, Co and Ti increases hydrogen uptake/release pressure. In one or more embodiments, inclusion of any one of more of Zr, Al, Cr, La, Ni, Ce, Ho, Mo and V decreases hydrogen uptake/release pressure.

The composition of ferrovanadium, abbreviated VFe, may vary according to the amount of each component element. Throughout this specification the terms “ferrovanadium” and “VFe” encompass all such variations. In an exemplary embodiment, ferrovanadium corresponds to (Fe₁₅₋₆₅V₃₅₋₈₅) in which the vanadium content in the ferrovanadium ranges from 35% to 85% and the iron in the ferrovanadium ranges from 15% to 65%. In preferred embodiments, ferrovanadium corresponds to (V_{0.85}Fe_{0.15}) or (V_{0.5}Fe_{0.5}). Ferrovanadium has advantages over pure vanadium, including being more accessible and less expensive. In addition, large amounts of vanadium leads to significant hysteresis, which is a disadvantage in hydrogen storage applications.

In preferred embodiments, the TiMn-based alloys of the invention have a hydrogen input pressure of about 30 bar and a hydrogen output pressure of at least 3 bar. Such alloys may be particularly suited for use in fuel cells.

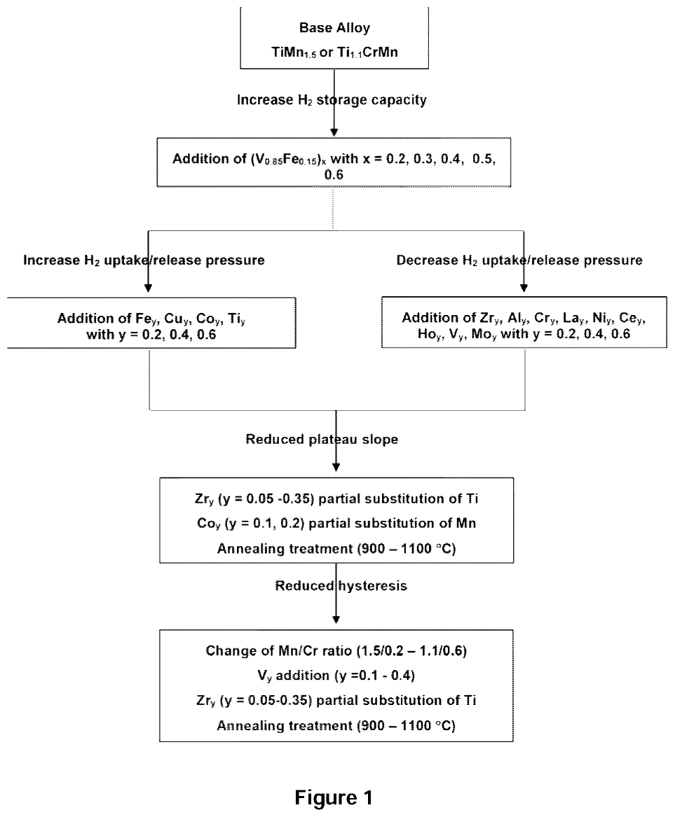

The present invention provides a principle of general application that enables the skilled person to prepare a hydrogen storage alloy having a requisite hydrogen storage property profile, by tuning the composition of the alloy to balance various properties of the alloy. Advantageously, the present invention may be broadly applied and is adaptable to specific alloy compositions, selected or preferred properties, or a desired outcome to be achieved. By understanding which modifications impact which properties of the alloy based on the teaching provided herein, the skilled person may apply the present invention to prepare hydrogen storage alloys. Advantageously, the present invention enables the modification or tuning of a range of hydrogen storage properties, which enables an alloy to be selected or produced to suit a particular end use. The ability to modify or tune properties of a hydrogen storage alloy in accordance with the present invention is illustrated in FIG. 1, which depicts a particularly preferred embodiment of the invention. FIG. 1 summarises the versatility of the present invention, which is premised on the inventors' recognition, development and application of different approaches for tuning hydrogen storage properties of alloys. Advantageously, one or all of the mechanisms for tuning various properties may be performed in any order on a case by case basis as required.

In accordance with one or more embodiments of the present invention, the TiMn-base alloy is TiMn_{1.5}. In other embodiments the TiCrMn-base alloy is Ti_{1.1}CrMn. In one or more embodiments the modifier element is selected from any one or more of VFe, Fe, Cu, Co, Ti, Zr, Al, Cr, La, Ce, Ho, V, Mo, preferably VFe and optionally at least one additional modifier element.

In one or more embodiments, hydrogen storage capacity may be increased by the addition of ferrovanadium (VFe) to the alloy. In one or more embodiments the ferrovanadium has the compositional formula Fe (15-65%)V (35-85%) or Fe (15-50%)V (50-85%). In one or more embodiments, [Fe (15-65%)V (35-85%)]ₓ or [Fe (15-50%)V (50-85%)]ₓ wherein x=0.1-0.8 or 0.2-0.6 is included in the alloy. In one or more preferred embodiments, (V_{0.85}Fe_{0.15})ₓ wherein x=0.2-0.6 is included in the alloy.

In one or more embodiments hydrogen uptake/release pressure may be increased by the inclusion of one or more modifier elements (M) in the alloy. In preferred embodiments the modifier element is selected from Zr, Fe, Cu, Co and Ti. In preferred embodiments, one or more of Zr_{y}, Fe_{w}, Cu_{w}, Co_{w} and Ti_{w} wherein y=0.1-0.6 and w=0.1-0.6, preferably wherein y=0.1-0.4 and w=0.1-0.4, is included in the alloy.

In one or more embodiments, hydrogen uptake/release pressure may be decreased by the addition of one or more modifier elements (M) to the alloy. In preferred embodiments the modifier element is selected from Zr, Al, Cr, La, Ni, Ce, Ho, V and Mo. In preferred embodiments, one or more of Zr_{y}, Al_{w}, Crᵤ, La_{w}, Ni_{w}, Ce_{w}, Ho_{w}, V_{w} and Mo_{w} wherein y=0.1-0.6, u=0.01-1, and w=0.01-0.6, preferably wherein y=0.1-0.4 and w=0.01-0.4, is added to the alloy.

In one or more embodiments, a reduction in plateau slope may be achieved by the addition of one or more modifier elements (M) to the alloy. In preferred embodiments a reduction in plateau slope may be achieved by partial substitution of Ti with Zr. For example, Ti may be partially substituted with Zr_{y} (wherein y=0.02-0.40, preferably y=0.05-0.35). In alternative embodiments, a reduction in plateau slope may be achieved by partial substitution of Mn with Co. For example, Mn may be partially substituted with Co_{w} (wherein w=0.05-0.3, preferably w=0.1, 0.2). In alternative embodiments, a reduction in plateau slope may be achieved by selecting an appropriate annealing treatment of the alloy. In preferred embodiments annealing is performed at a temperature of about 800° C. to about 1200° C., preferably about 850° C. to about 1150° C., more preferably about 900° C. to about 1100° C.

Additional embodiments relate to methods reducing hysteresis. In one or more embodiments this may be achieved by the addition of one or more modifier elements (M) to the alloy, or by modifying the ratio of elements within the alloy. For example, hysteresis may be reduced by modifying the Mn/Cr ratio to a ratio of about 1.6/0.2 to about 1.0/0.8, preferably about 1.5/0.2 to about 1.1/0.6. In alternative embodiments, hysteresis may be reduced by the addition of vanadium to the alloy. In preferred embodiments, vanadium may be added to the alloy in an amount V_{Y} wherein y=0.05-0.5, preferably 0.1-0.4. In alternative embodiments hysteresis may be reduced by partial substitution of Ti with Zr. For example, Ti may be partially substituted with Zr_{y} (wherein y=0.02-0.40, preferably y=0.05-0.35). In alternative embodiments, a reduction in hysteresis may be achieved by selecting an appropriate annealing treatment of the alloy. In preferred embodiments annealing is performed at a temperature of about 800° C. to about 1200° C., preferably about 900° C. to about 1100° C.

In other embodiments disclosed herein the invention provides methods for regulating the hydrogen equilibrium plateau pressure by the addition of one or more modifier elements. Further embodiments disclosed herein relate to methods for tuning the temperature for hydrogen uptake/release by the addition of modifier elements to the alloy.

Advantageously, the properties of the alloy composition may be tuned by the addition of one or more modifier elements. Suitable modifier elements include vanadium, ferrovanadium, iron, zirconium, cobalt, copper, copper, palladium, molybdenum, niobium, tungsten, platinum, silver, or combinations thereof. In preferred embodiments, suitable modifier elements may be selected from ferrovanadium (VFe), iron (Fe) and zirconium (Zr). In accordance with embodiments of the invention, ferrovanadium is generally preferred over vanadium because pure vanadium at high concentration is expensive to produce, and ferrovanadium may be easier to source. In preferred embodiments the ferrovanadium is V_{0.85}Fe_{0.15}. In alternative embodiments, the ferrovanadium is V_{0.5}Fe_{0.5}.

In one or more embodiments of the invention, the alloy composition does not comprise nickel.

In one or more embodiments of the invention, the alloy composition does not comprise pure vanadium.

In accordance with embodiments of the invention, addition of ferrovanadium to the alloy increases hydrogen storage capacity. Advantageously, improving capacity facilitates hydrogen release at ambient temperatures.

In accordance with embodiments of the invention, addition of Fe increases plateau pressure, while addition of Zr decreases the plateau pressure. This has the advantage of enabling the profile of a particular alloy to be tuned to reflect a particular environment of deployment. In preferred embodiments, metal alloys of the present invention exhibit a relatively small differential between the hydrogen absorption pressure and hydrogen desorption pressure. Preferred embodiments of the invention enable alloys to be devised that have a substantially flat plateau pressure reflective of low hysteresis, and a substantially constant pressure for absorption/desorption.

In an exemplary embodiment of the invention, the alloy comprises, or consists essentially of, an elemental composition range: Ti (18-40 wt %), Mn (25-60 wt %), Cr (0-25 wt %), VFe (0-10 wt %), Fe (0-10 wt %) and Zr (10-15 wt %), preferably Ti (18-40 wt %), Mn (25-60 wt %), Cr (0-25 wt %), VFe (0.5-10 wt %), Fe (0-10 wt %) and Zr (10-15 wt %).

Exemplary alloy compositions derived from Ti_{1.1}CrMn or TiMn_{1.5} base alloys in accordance with the present invention include:

| Ti_{1.1}CrMn | TiMn_{1.5} |
|---|---|
| Ti_{1.1}CrMn(V_{0.85}Fe_{0.15})_{0.2} | TiMn_{1.5}(V_{0.85}Fe_{0.15})_{0.2} |
| Ti_{1.1}CrMn(V_{0.85}Fe_{0.15})_{0.4} | TiMn_{1.5}(V_{0.85}Fe_{0.15})_{0.4} |
| Ti_{1.1}CrMn(V_{0.85}Fe_{0.15})_{0.4}Zr_{0.2} | TiMn_{1.5}(V_{0.85}Fe_{0.15})_{0.4}Zr_{0.2} |
| Ti_{1.1}CrMn(V_{0.85}Fe_{0.15})_{0.4}Zr_{0.3} | TiMn_{1.5}(V_{0.85}Fe_{0.15})_{0.4}Zr_{0.3} |
| Ti_{1.1}CrMn(V_{0.85}Fe_{0.15})_{0.4}Zr_{0.4} | TiMn_{1.5}(V_{0.85}Fe_{0.15})_{0.4}Zr_{0.4} |

In a preferred embodiment, the metal hydride alloy has the composition: TiMn_{1.5}(V_{0.85}Fe_{0.15})_{0.4}.

Advantageously, metal alloys in accordance with preferred embodiments of the present invention are capable of storing relatively large amounts of hydrogen (e.g., at least 2 wt % H₂, or least 2.5 wt % H₂, or at least 3 wt. %, or at least 3.5 wt. %, or at least 4 wt. %, or at least 4.5 wt % H₂, or at least 5 wt % H₂, or at least 5.5 wt % H₂, or at least 6 wt % H₂), including at moderate temperatures and pressures. In preferred embodiments, suitable temperatures may be 40° C. or less, 30° C. or less, 25° C. or less, 20° C. or less, 15° C. or less, or 10° C. or less. In preferred embodiments, the pressure may be up to 100 bar, for example, pressures in the range of 30 bar to 100 bar or 30 bar to 50 bar. In an exemplary preferred embodiment, the hydrogen storage conditions are about 10° C. at a pressure of 30 to 100 bar, more preferably about 10° C. at about 30 bar.

In preferred embodiments, metal hydride alloys of the present invention are capable of desorbing a substantial amount of hydrogen (e.g., >65%, or >70%, or >75%, or >80%, or >85%, or >90%) at relatively low pressures, e.g., pressure of about 30 bar.

The present invention relates to hydrogen storage alloys for the reversible storage of hydrogen. More particularly, the invention relates to metal hydride alloys that can uptake and release hydrogen, preferably under the strict input/output conditions of an electrolyser and fuel cell, respectively, which generally operate with 30-3 bar pressure at −25° C. with hydrogen flow rates in the range of 500 litres per hour, which equates to 0.749 g of H₂ per min. Accordingly, an advantage of particularly preferred embodiments of the present invention is that the metal hydride alloys are capable of rapid uptake and release of hydrogen. For example, in preferred embodiments the metal hydride alloys may have charging/discharging rates of at least about 0.5 g H₂/min, or at least about 0.75 g H₂/min, or at least about 1.0 g H₂/min, or at least about 1.25 g H₂/min, or at least about 1.4 g H₂/min, which provides a significant advantage over known previously known alloys.

A particularly preferred embodiment of the present invention is directed towards metal hydride alloys capable of achieving at least 1.44 g per min in terms of hydrogen uptake or release at a temperature of about 10° C. Advantageously, in preferred embodiments of the alloys of the present invention at least 70%, or at least 75% or at least 80% of the hydrogen is absorbed or released at a temperature of about 10° C.

The inventors have surprisingly found that a suitable hydrogen storage alloy may be identified and characterised by its equilibrium plateau pressure, also termed Pressure-Composition Temperature, (PCT). This enables the composition of an alloy to be tuned according to a desired or ideal PCT suitable for a particular end use or environment, by the addition of appropriate modifier elements and/or modifying the ratios of various elements in the alloys.

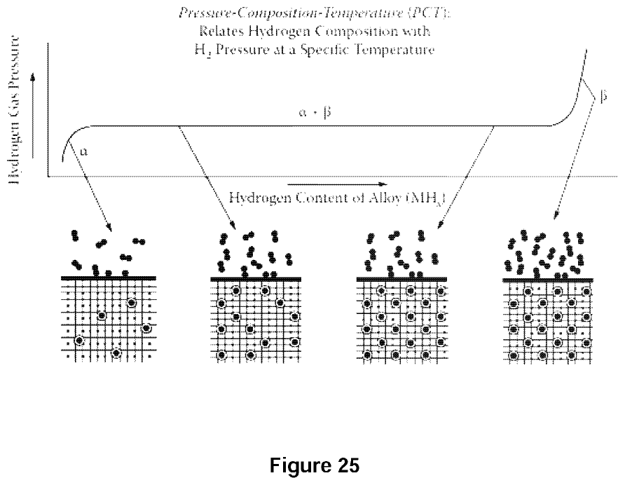

FIG. 25 (extracted from Klebanoff, L. Hydrogen storage technology: materials and applications; CRC Press, 2012) illustrates an ideal case of hydrogen storage on Pressure-Composition-Temperature PCT.

Thus, alloys in accordance with the present invention may be identified or characterised according to the ideal hydrogen storage properties as depicted in FIG. 25.

As illustrated in FIG. 25, an ideal case is when an optimal hydrogen storage material is being used to absorb hydrogen. The graph shows two single-phases (α and β) and one equilibrium plateau (α+β) region. When hydrogen gas is introduced into the storage container that holds the pure metal or alloys at a specific temperature, hydrogen gas is first dissociated on the surface of the metal and forms atomic hydrogen. This atomic hydrogen then diffuses within the metal to form a solid solution (hydrogen dissolved in the metal), the so-called α phase.

Further increase in hydrogen pressure above the equilibrium plateau, allows for more hydrogen to be absorbed by the metal. During this process, the pressure in the vessel remains constant (flat plateau), and the hydrogen dissolved in the metal starts to bind with the metal to form the metal hydride (MHx) and the so-called β phase. During that process, both a and β phase co-exist until all the metal sites are bonded with hydrogen, i.e., the metal is fully converted to the hydride. When this stage in reached, the pressure in the vessel increases.

Having a flat plateau pressure, means that hydrogen can be absorbed at a constant pressure (deliver by an electrolyser). Vice versa, having a flat plateau means that hydrogen can be delivered at a constant flow and pressure to the fuel cell. Having no or minimal hysteresis (i.e., pressure gap between the equilibrium absorption and desorption plateau) is desirable for practical applications and to simplify the engineering design and economic operation of electrolysers and fuel cells when attempting to couple electrolysers/hydrogen storage systems/fuel cells.

Surprisingly, the inventors have found that it is possible to tune TiMn- and TiCrMn-based alloys to increase hydrogen uptake/release plateau pressure by the addition of particular modifier elements, including ferrovanadium (VFe), iron (Fe), copper (Cu), cobalt (Co) and titanium (Ti). In addition, the inventors have also found it is possible to decrease hydrogen uptake/release plateau pressure by the addition of modifier elements, including zirconium (Zr), aluminium (Al), chromium (Cr), lanthanum (La), cerium (Ce), holmium (Ho), molybdenum (Mo) and vanadium (V).

Thus, the inclusion of one or more modifier element(s) in accordance with the present invention confers the advantage of enabling the pressure level at which the alloy material can release hydrogen to be modified or tuned. For example, one or more modifier elements may be incorporated into the alloy composition to shift the plateau pressure upwards to enable hydrogen to be absorbed and released at higher pressure levels, or conversely, one or more modifier elements may be incorporated into the alloy composition to shift the plateau pressure downwards to enable hydrogen to be absorbed and released at lower pressure levels. This allows the alloy and its properties to be modified or tuned to suit different environments. In addition, modifier elements may also form an additional hydride phase, which can assist in tuning the storage capacity of the alloy and plateau pressure.

In a particularly preferred embodiment, the inventors have found that the hydrogen storage capacity of TiMn and TiCrMn based alloys may be increased by the addition of ferrovanadium (VFe). Ferrovanadium has an advantage of being readily available and less expensive than high purity vanadium. In addition, excessive pure vanadium results in large hysteresis, which is disadvantageous for hydrogen storage applications.

A further advantage of the present invention is that it involves the use of metals that are readily accessible and relatively inexpensive and thus, the alloys may be suitable for various commercial applications, including in electrolyser or fuel cells in industrial and residential environments.

In another aspect the invention relates to the use of an alloy comprising an elemental composition range of: Ti (18-40 wt %), Mn (25-60 wt %), Cr (0-25 wt %), M (0.1-35 wt %), wherein M is a modifier element selected from one or more of VFe, Fe, Cu, Co, Ti, Zr, Al, Cr, La, Ni, Ce, Ho, Mo and V, to store hydrogen, and wherein the amount or proportion of each modifier element is selected independently.

In a further aspect the invention relates to a process for manufacturing an alloy comprising an elemental composition range of: Ti (18-40 wt %), Mn (25-60 wt %), Cr (0-25 wt %), M (0.1-35 wt %), wherein M is a modifier element selected from one or more of VFe, Fe, Cu, Co, Ti, Zr, Al, Cr, La, Ni, Ce, Ho, Mo and V, the process comprising arc melting the component metals in one or more arc melting steps to form an alloy, and annealing the alloy.

### Hydrogen Absorption and Desorption

Rare-earth and transition metals may be melted into alloys using vacuum technology. The alloys are able to absorb hydrogen from the gas phase. Such alloys, at room temperature and under certain hydrogen pressure, are capable of absorbing large quantities of hydrogen through the formation of solid metal hydrides. The hydrogen absorption process may be reversed if the hydrogen pressure is lowered below a particular value. Whilst the chemical reaction involved in hydride formation and hydrogen absorption is accompanied by the release of heat into environment, desorption of hydrogen gas is accompanied by heat absorption from the environment.

### Features of One or More Embodiments of the Invention

In particularly preferred embodiments, the invention relates to Ti—Mn alloys that have a reversible hydrogen gravimetric storage capacity of at least 2 wt. % and a volumetric density of at least 100 kg m⁻³. In preferred embodiments, the Ti—Mn alloys have a reversible hydrogen gravimetric storage capacity of at least 2.5 wt. %, or at least 2.75 wt. %, or at least 3 wt. %, or at least 3.5 wt. %, or at least 4 wt. %, or at least 4.5 wt. %, or at least 5 wt. %, or at least 5.5 wt. %, or at least 6 wt. %.

In preferred embodiments, the invention relates to Ti—Mn alloys that are capable of absorbing and releasing hydrogen under ambient temperature and moderate pressure conditions. In preferred embodiments, the process of tuning the properties of the alloy includes adding one or more modifier elements that reduce the equilibrium plateau pressure for hydrogen uptake/release.

In a preferred embodiment, the alloy may use ambient heat from its surrounding to release hydrogen in the temperature range from about −20° C. to about 50° C.

In a preferred embodiment, the alloy ideally exhibits minimal (e.g., near zero) hysteresis between the hydrogen absorption and hydrogen release equilibrium plateau. This property is particularly advantageous as the alloy may be easier to operate in conjunction with an electrolyser and fuel cell.

In a preferred embodiment, the invention relates to an alloy capable of delivering H₂ at a pressure of about 3 bar. Advantageously, such an alloy may feed current fuel cells on the market at a flow rate of about 500 litres per hour.

In another preferred embodiment, the invention relates to an alloy that can uptake H₂ at a flow rate of at least 250 litres per hour, or at least 300 litres per hour, or at least 350 litres per hour, or at least 400 litres per hour, or at least 450 litres per hour, or at least 500 litres per hour, preferably at least 500 litres per hour, at a maximum pressure of 30 bar.

In preferred embodiments, metal hydride alloys of the present invention are capable of achieving at least 70% (relative to maximum capacity) hydrogen uptake within a period less than about 10 minutes, preferably less than about 5 minutes. In a particularly preferred embodiment, metal hydride alloys of the present invention are capable of achieving at least 80% hydrogen uptake within about 3 minutes.

A further advantage of the alloys according to the present invention is that they are composed of readily accessible materials that are relatively inexpensive, and do not rely on expensive or rare metals, such as pure vanadium.

In accordance with one or more embodiments of the present invention, the alloys may be tuned to respond to changing demand in H₂ pressure uptake/release as a function of temperature, i.e., geographical location of the hydrogen storage system so that ambient heat may be used as a source of energy to release hydrogen from the alloy. In preferred embodiments ambient heat may be used as the sole source of energy to release hydrogen from the alloy.

In a further embodiment the present invention relates to alloys that are not pyrophoric once activated. This provides a further advantage as the vessel housing the alloy material may be easily maintained without compromising safety or risk of fire existing in case the vessel is accidentally pierced or compromised.

In preferred embodiments, alloys in accordance with the present invention advantageously may be exposed to air once activated with substantially no oxidation and with minimal hydrogen storage capacity loss.

In preferred embodiments the present invention relates to Ti—Mn alloys capable of being manufactured in air without compromising H₂ activation and storage capacity.

Advantageously, in one or more preferred embodiments alloys in accordance with the present invention may exhibit fast hydrogen kinetics, for example, less than 15 minutes for uptake/release at more than 90% of the storage capacity. In particularly preferred embodiments, these kinetics are achieved without the use of a catalyst. This is an important advantage as known alloys typically require and use catalysts based on expensive transition metals, e.g., Pd, Pt, Ru, etc.

In preferred embodiments, alloys according to the present invention may be capable of withstanding numerous (e.g., more than 5,000, more than 10,000 or more than 15,000 cycles) and are not prone to disproportionation after cycling. That is, in preferred embodiments of the invention at least 80%, or at least 85%, or at least 90%, or at least 95% of the hydrogen stored can be reversibly released upon multiple hydrogen absorption/desorption cycling.

An advantage of one or more preferred embodiments of the invention disclosed herein is the provision of a cost effective alloy for bulk storage of hydrogen, where the raw starting materials/elements are abundant.

In one or more preferred embodiments the invention relates to alloys that can be specifically tuned to meet the strict requirements of fuel cells, i.e., deliver hydrogen at least 2 bar, and electrolysers, i.e., uptake hydrogen from at least 35 bar, and effectively work in tandem with both devices.

In one or more preferred embodiments the invention relates to alloys that are tuned or adapted to work in conjunction with an electrolyser and fuel cell. Suitable properties of the alloys include a flat equilibrium plateau pressure so the alloy can uptake hydrogen from a constant hydrogen supply delivered by the electrolysers and release hydrogen to the fuel cell at a constant pressure. As disclosed herein, and in accordance with the present invention, this may be achieved by one or more mechanisms including, for example, a partial substitution of Ti using Zr, a partial substitution of Mn with Co, a partial substitution of Mn with Mo, adjustment of V and Al content, through annealing at a temperature of from 800° C. to 1200° C., preferably 900° C. to 1100° C., e.g., at least 1000° C., and combinations thereof.

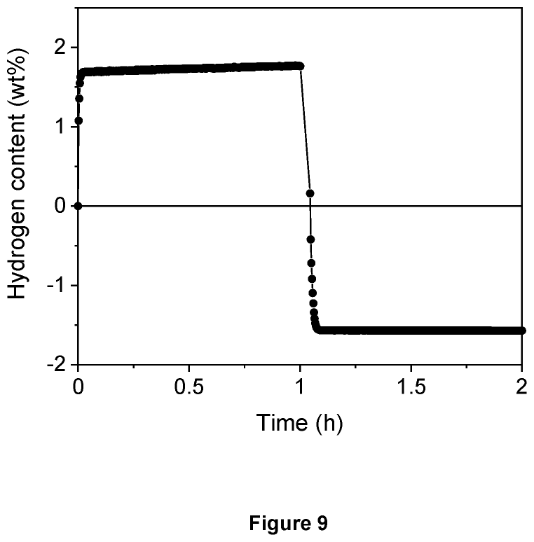

In one or more preferred embodiments, the invention relates to a room temperature alloy, that does not require additional heat to release or uptake hydrogen and thus can fully store hydrogen at ambient temperature with an efficiency >80%, preferably >85%, >90% or >95%. That is, substantially all of the hydrogen may be fully absorbed and released from the alloy with substantially no hydrogen remaining in the alloy, preferably with fast rates of hydrogen uptake and release. This is illustrated in FIG. 9 for a representative alloy according to the invention. FIG. 9 demonstrates hydrogen uptake (30 bar) and release (0.5 bar) at room temperature for the representative alloy Ti_{0.9}Zr_{0.15}Mn_{1.1}Cr_{0.6}Co_{0.1}(V_{0.85}Fe_{0.15})_{0.3} showing full uptake and full hydrogen release at >95% efficiency and an extremely fast rate of hydrogen sorption (<2 min to reach full capacity).

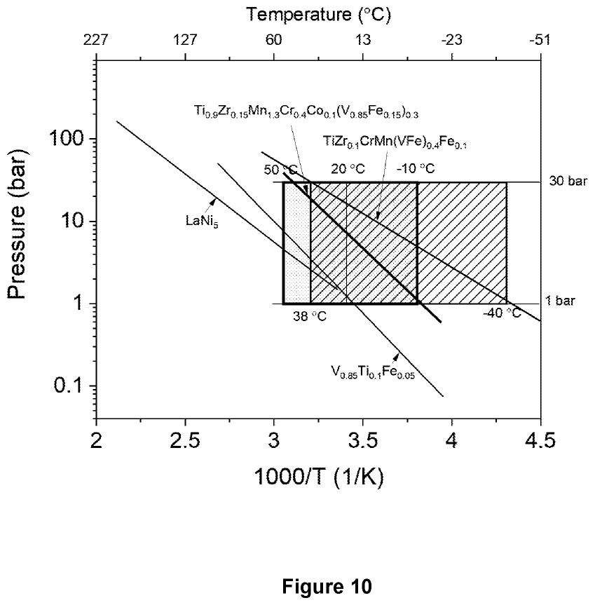

In one or more preferred embodiments the invention relates to an alloy that can be tuned to adjust its hydrogen uptake and release conditions as a function of the ambient temperature (and pressure) to meet varied temperature-pressure work ranges, such as regional temperature variations e.g., working temperatures from 50 to −10° C. or 38 to −40° C. Advantageously, as illustrated in FIG. 10, this is especially useful where the technology is to be used in conjunction with an electrolyser and/or fuel cell (in the example shown, 30 bar feed from the electrolyser and 1 bar feed to the fuel cell).

In one or more preferred embodiments the invention relates to an alloy that has a narrow hysteresis between the equilibrium absorption and desorption plateau. Advantageously, such alloys are capable of meeting the requirements to work in conjunction with an electrolyser and fuel cell. In particular, such alloys having a narrow hysteresis are suitable to work within a defined temperature window related to ambient temperature conditions and not require additional heat management to assist the hydrogen uptake or release. This may be achieved by a range of strategies or combinations thereof in accordance with embodiments of the invention disclosed herein, including variations of the Mn/Cr ratio, Zr partial substitution of Ti, Co, V partial substitution of Mn, Co adjustment, Al, and alloy annealing.

In one or more preferred embodiments, the invention relates to an alloy that has a reversible hydrogen storage capacity of at least 1.5 wt %, preferably at least 1.8 wt % and better than 2 wt % at 25° C. at 30 bar hydrogen sorption pressure, while meeting the requirements to work in conjunction with an electrolyser and fuel cell. This may be achieved in accordance with embodiments disclosed herein, for example, by fine tuning one or more of a range of elements including Ti, Zr, Mn, Cr, VFe, V, Fe, Co and Al content.

In one or more preferred embodiments, alloys of the present invention have a C14 Laves phase crystalline microstructure. The C14 Laves phase may provide advantageous hydrogen storage properties of the alloys, including for example, hydrogen storage capacity and plateau pressure.

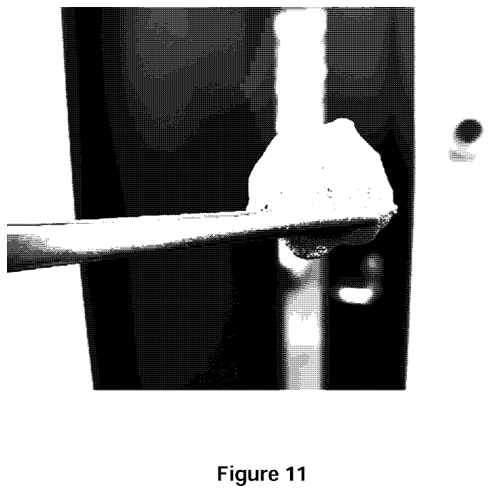

In one or more preferred embodiments the invention relates to an alloy that is non pyrophoric. Such alloys have advantages in terms of safety, and may also have additional benefits of being suitable for large scale production and cost reduction in manufacturing. For example, once the alloy has been removed from the furnace where individual elements are melted to form the alloy, the alloy can be fully handled in air and further processed before final use in a storage vessel. FIG. 11 illustrates a representative alloy in accordance with the present invention which has been exposed to air without showing pyrophoricity.

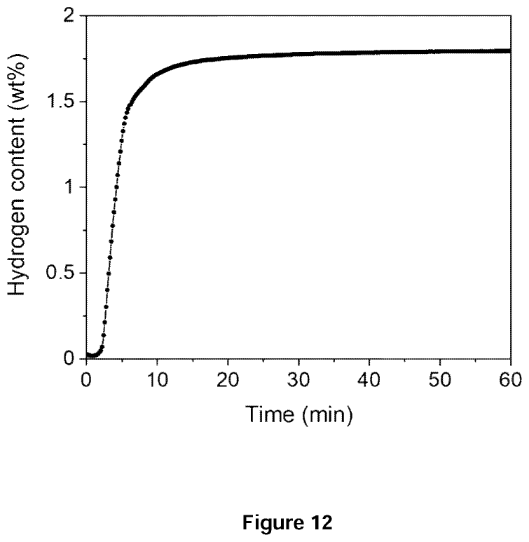

In one or more preferred embodiments, the invention relates to an alloy that can be activated at room temperature within a few minutes, e.g., about 1-10 minutes, more preferably about 1-5 minutes, e.g., within about 1 minute, about 1.5 minutes, about 2 minutes, about 2.5 minutes, about 3 minutes, about 3.5 minutes, about 4 minutes, about 4.5 minute, about 5 minutes, about 6 minutes, about 7 minutes, about 8 minutes, about 9 minutes, or about 10 minutes. In accordance with this embodiment the alloy may fully and reversibly store hydrogen upon the first cycle, without the need of additional heat, by simply applying a suitable hydrogen pressure, e.g., hydrogen pressure of about 30 bar, corresponding to the pressure of a standard electrolyser. This is illustrated by FIG. 12, which shows activation of a representative alloy (Ti_{0.9}Zr_{0.15}Mn_{1.05}Cr_{0.5}Co_{0.1}Fe_{0.15}(V_{0.85}Fe_{0.15})_{0.3}) at room temperature under 30 bar hydrogen pressure with only about 2 minutes incubation time. This provides additional benefits, including in relation to cost, for large scale manufacturing.

### Synthesis

The alloys of the present invention may be produced by conventional methods well known to those skilled in the art, such as induction furnaces, vacuum technologies, e.g., arc melting, plasma furnaces or similar processes, which are typically performed in an inert atmosphere, e.g., 99.99% argon, or the like. Other methodologies known to those skilled in the art include:
gas atomisation for alloy powder manufacturing, including plasma atomisation;
additive manufacturing, including electron beam melting (‘e-beam’, or ‘EBM’), and methods starting from powdered starting elements; and
pyrometallurgy; including combustion synthesis.

Arc melting may be particularly useful for small or laboratory scale alloy manufacture. For industrial-scale manufacture, induction melting and plasma electron beam melting may be used. The general procedure for industrial-scale melting is as follows:
1) Raw materials drying—Prior to the charge into the melting furnace, raw materials are generally dried in oven at 100-150° C. overnight to remove absorbed moisture.
2) Induction melting or plasma melting—Raw materials are generally charged into the melting furnace layer by layer. The furnace chamber is then purged with high purity Ar (99.99%) for at least three times to remove air inside the furnace chamber. The raw materials are then melted 1-6 times, typically 2-6 times by step-by-step increase of the melting power.
3) Cooling—The alloy is then cooled to room temperature before opening the furnace to retrieve the alloy ingot.

In preferred embodiments disclosed herein, including in the Examples, the alloys are synthesised by an arc melting process.

The melting temperature of various elements used in alloy compositions according to the present invention are as follows: Ti: 1668° C.; Mn: 1246° C.; Cr: 1907° C.; VFe: 1480° C.; Fe: 1538° C. and Zr: 1855° C.

The synthesis temperature used to prepare the alloy can be varied according to the particular material composition. Typical synthesis temperatures will be within the range of approximately 1300° C.-2000° C., preferably 1200° C. to 900° C. A preferred upper limit for the annealing process for alloys in accordance with the present invention is about 1200° C., which is below the melting temperature of Mn (1246° C.). Accordingly, the annealing process may be performed at a temperature in the range of about 800° C. to about 1200° C., for example, about 800° C., or about 850° C., or about 900° C., or about 950° C., or about 1000° C., or about 1100° C., or about 1150° C., or about 1200° C.

In general, when performing the arc melting process metals having a higher melting temperature are melted first, so as to reduce the fumes from the other metals and minimize elemental loss to reach the appropriate composition. Those skilled in the art will appreciate that it may be necessary to adjust the amount of lower melting temperature metals added to the mixture to account for loss when exposed to higher melting temperatures required for other metals. By way of illustration, a process to prepare an exemplary alloy, such as TiMn_{1.5}(V_{0.85}Fe_{0.15})_{0.4}, will first involve adding each of the component elements into the arc-melter all together. The general approach will be to focus the melting on the high temperature metals, e.g., Ti (and Cr or V if being used), then while the high melting temperature metals are being melted, the lower temperature metals such as Mn will be infused into the molten elements forming the alloy. The general process steps are as follows:
1) Prepare the appropriate quantity of all of the elements to form the required composition of the alloy.
2) Place all of the elements in the arc-melter under an inert atmosphere.
3) Commence melting the higher temperature metals, e.g., Ti, followed by melting the lower melting temperature elements, e.g., VFe, Cr, Zr, Mn.

In preferred embodiments, the process comprises managing (i.e., controlling or preferably reducing) the evaporation rate of individual elements, such as Mn, to less than 0.2%, preferably less than 0.1%. In preferred embodiments this may be achieved by controlling power output and the amount of heat used to alloy the various elements. Power output may be controlled by incremental power increase. By way of illustration, in an embodiment power output may be controlled by incremental power increase, e.g., from 0 to 30% full power output for about 1 to 5 minutes, then from 30% to 50% full power output for about 1 to 5 minutes, and finally from 50% to 80% full power output for 1 to 5 minutes. Low boiling point elements may be added to the alloy during the final re-melting to limit their evaporation and achieve a final alloy with a control of the final elemental composition, preferably at 0.2% or less, more preferably to 0.1% or less.

Preferably, the process utilises high purity starting elements, e.g., 99% purity or higher. In preferred embodiments, the purity of the starting materials and their reprocessing may be controlled by re-melting under vacuum to remove volatiles including oxygen, nitrogen and chloride.

In preferred embodiments, the process uses high vacuum. In such embodiments, the process may include several purging steps involving vacuuming the furnace and re-filling with an inert gas such as argon, helium, or nitrogen, to remove oxygen and residual water from the furnace melting chamber.

To improve homogeneity of the alloy, the alloy may be remelted one or more times. For example, the alloy typically may undergo 2-10, 2-8, or 4-6 melting cycles as appropriate or required in the circumstances. For example, the process may include at least 3 re-melting steps for 3 to 15 minutes melting each time with an arc-melter, depending of the size of the ingot (e.g., 1 g to 1 Kg). Advantageously, adjusting the melting time and the number of re-meltings may be used to achieve a high homogeneity of the alloy and/or a preferred microstructure. In particularly preferred embodiments alloys in accordance with the present invention have a C14 laves phase, preferably a C14 laves phase with a crystalline cell volume of 162-169 Angstrom³.

The process may further include controlling the cooling rate (e.g., from 100° C. to 70° C. per min per gram of alloy) to achieve a preferred microstructure, e.g., C14 laves phase microstructure.

Once melted, the melted alloy may be cooled into alloy ingots. In an embodiment the arc-melting furnace may have a water-cooling system, e.g., underneath a copper crucible, which helps cool down the ingot, and avoids the use of a rapid quenching step, which has the advantage of simplifying the manufacturing process. Thus, in accordance with one or more preferred embodiments of the present invention, the synthesis process for manufacturing the alloy does not include a rapid quenching step.

After the arc-melting step, the alloy may be crushed, ground or pulverised to form small particles, preferably having a particle size of 10 mm or less, more preferably 5 mm or less. The ideal particle size may be determined and adjusted if necessary in light of hydride bed expansion.

Typically, activation of the alloy is performed via multiple (e.g., 10 or more, 15 or more, or 20 or more) full charge/discharge hydrogen cycles. Typically, high purity hydrogen is fed into the vessel housing the alloy at a pressure of about 30 bar and a temperature of about 25° C. and released from the vessel at about 1 bar. Each full absorption or desorption of the vessel typically takes approximately one hour. Hydrogen used during the activation process preferably has 99.999% purity or higher.

Metal alloys may be prone to corrosion if exposed to oxygen and water vapour. In addition, activated metal alloys may be prone to fire upon exposure to air. Accordingly, in a further embodiment the invention provides a method to reduce or alleviate oxidation and enable the alloys to be exposed to air and other poisons (i.e., oxygen, water vapour, carbo monoxide, etc) without significant corrosion or risk of fire. In accordance with this embodiment of the invention, polymers and surfactants may be used to coat the alloy composition to provide resistance to oxidation, and prevent burning if the alloy is exposed to air after hydrogen activation. Suitable polymers are hydrophobic polymers and include, for example, high density polyethylene (HDPE), polytetrafluoroethylene (PTFE, e.g., Teflon®), acrylonitrile butadiene rubber (Buna N), fluoroelastomers (e.g., Viton A®), and the like. Suitable surfactants include silane-based surfactants, which preferentially bind to titanium to form a hydrophobic surface. As a further advantage, improving resistance to poisoning and corrosion by the application of a polymer coat to the alloy may also improve the hydrogen absorption-desorption cycle performance. Preferably, the polymer or surfactant coating may be applied before activation of the alloy.

### Further Embodiments

Further embodiments disclosed herein relate to a method for making a TiMn- or TiCrMn-based hydrogen storage alloy, which comprises including ferrovanadium (VFe) and optionally one or more modifier elements (M) in the alloy to modify or tune a property of the alloy.

One further embodiment relates to a method for making a TiMn- or TiCrMn-based hydrogen storage alloy having a property profile, the method comprising modifying the composition of the alloy to achieve the property profile,
wherein modifying the composition of the alloy comprises at least one of:
(a) including one or more modifier elements (M) in the alloy;
(b) modifying the ratio of two or more elements in the alloy; and
(c) annealing the alloy at an annealing temperature of between 900° C. to 1200° C.

In one or more embodiments, modifying the composition of the alloy comprises including VFe and optionally one or more additional modifier elements (M) in the alloy.

In one or more embodiments, the property profile comprises at least one property selected from increased H₂ storage capacity, increased H₂ uptake/release pressure, decreased H₂ uptake/release pressure, reduced plateau slope, reduced hysteresis, and substantially flat equilibrium plateau pressure.

In one or more embodiments, the property profile comprises increased H₂ storage capacity, and modifying the composition comprises including VFe in the alloy.

In one or more embodiments, the property profile comprises increased H₂ uptake/release pressure, and modifying the composition comprises including at least one modifier element selected from Fe, Cu, Co and Ti.

In one or more embodiments, the property profile comprises decreased H₂ uptake/release pressure, and modifying the composition comprises including at least one modifier element selected from Zr, Al, Cr, La, Ni, Ce, Ho, V and Mo.

In one or more embodiments, the property profile comprises reduced plateau slope, and modifying the composition comprises including at least one modifier element selected from Zr and Co. In one or more embodiments, Zr is added as a partial substitution of Ti. In one or more embodiments Co is added as a partial substitution of Mn.

In one or more embodiments, the property profile comprises reduced hysteresis, and modifying the composition comprises at least one of:
(i) modifying the ratio of Mn and Cr in the alloy,
(ii) including VFe in the alloy, and
(iii) including Zr as a partial substitution of Ti.

In one or more embodiments the method comprises annealing the alloy at a temperature of from 900° C.-1100° C.

In one or more embodiments, the property profile is suitable for the alloy to work in conjunction with an electrolyser and fuel cell. In one or more embodiments, the property profile of the alloy comprises a substantially flat equilibrium plateau pressure. In one or more embodiments the substantially flat equilibrium plateau pressure enables the alloy to uptake hydrogen from a constant hydrogen supply delivered by the electrolyser and release hydrogen to the fuel cell at a constant pressure.

In one or more embodiments, the alloy has a reversible hydrogen storage capacity of at least 1.5 wt %, 1.6 wt %, 1.7 wt %, 1.8 wt %, 1.9 wt %, or 2 wt %, or at least 2.25 wt % or at least 2.5 wt %, or at least 2.75 wt %, or at least 3 wt % at 30 bar.

In one or more embodiments, the alloy is capable of storing hydrogen at ambient temperature with an efficiency of at least 80%, at least 85%, at least 90% or at least 95%.

In one or more embodiments, the hydrogen storage alloy has the formula TiₓZr_{y}Mn_{z}Crᵤ(VFe)ᵥM_{w}, wherein
M is a modifier element selected from one or more of V, Fe, Cu, Co, Mo, Al, La, Ni, Ce and Ho;
x is 0.6-1.1;
y is 0-0.4;
z is 0.9-1.6;
u is 0-1;
v is 0-0.6 (preferably v is 0.01-0.6)
w is 0-0.4

In one or more embodiments, v is 0.05-0.6. In one or more embodiments, VFe is (V_{0.85}Fe_{0.15}). In one or more embodiments, x is 0.9-1.1. In one or more embodiments, y is 0.1-0.4. In one or more embodiments, z is 1.0-1.6. In one or more embodiments, u is 0.1-1. In one or more embodiments, w is 0.02-0.4.

In one or more embodiments, the alloy has a C14 Laves phase structure.

### EXAMPLES

### Example 1: Manufacture of an Exemplary TiMn_{1.5} Alloy (Laboratory Scale)

### Step 1—Arc Melting

Arc melting was performed in a copper hearth crucible, under an inert high purity atmosphere (e.g., 99.99% Argon).

For TiMn_{1.5}, titanium and manganese need to be melted to achieve a 1:1.5 stoichiometric ratio in the alloy. During the melting process, high melting temperature metals are melted first, so as to reduce the fumes from the other metals. In this example, titanium was melted first and manganese was kept in close contact with the titanium metal to allow the manganese to fuse into the molten titanium metal for sufficient time to ensure that all titanium and manganese had been melted together. The melting step was repeated six times and the alloy flipped each cycle to form a homogenised alloy.

NOTE 1: As manganese melts at a much lower temperature than titanium, it was necessary to use a slightly higher amount.
NOTE 2: Titanium has a strong affinity to oxygen, therefore it is important to conduct the melting under an inert atmosphere to minimise oxidisation of the titanium.

### Step 2—Annealing Treatment

Annealing was performed at a temperature of 900° C. (ramp rate of 10° C./min), under a high purity inert atmosphere (Argon at 99.99%). The alloy was heated and maintained at a temperature of 900° C. for a period ranging from 2 to 24 hours to facilitate homogenisation of the alloy. The alloy was then allowed to cool naturally.

### Step 3—Crushing

The alloy may optionally be crushed into particles having a diameter of approximately 5 mm under a normal ambient atmosphere.

Table 1 summarises various representative alloy compositions made in accordance with the above process.

TABLE 1

| | Mass Percentage (%) | | | | | |
|---|---|---|---|---|---|---|
| Alloy Composition | Ti | Cr | Mn | V | Fe | Zr |
| Ti_{1.1}CrMn | 33 | 33 | 34 | — | — | — |
| Ti_{1.1}CrMn(V_{0.85}Fe_{0.15})_{0.2} | 31 | 31 | 32 | 5 | 1 | — |
| Ti_{1.1}CrMn(V_{0.85}Fe_{0.15})_{0.4} | 29 | 29 | 30 | 10 | 2 | — |
| Ti_{1.1}CrMn(V_{0.85}Fe_{0.15})_{0.4}Zr_{0.2} | 26 | 26 | 28 | 9 | 2 | 9 |
| Ti_{1.1}CrMn(V_{0.85}Fe_{0.15})_{0.4}Zr_{0.3} | 25 | 25 | 26 | 8 | 2 | 13 |
| Ti_{1.1}CrMn(V_{0.85}Fe_{0.15})_{0.4}Zr_{0.4} | 24 | 24 | 25 | 8 | 2 | 17 |
| TiMn_{1.5} | 37 | — | 63 | — | — | — |
| TiMn_{1.5}(V_{0.85}Fe_{0.15})_{0.2} | 34 | — | 59 | 6 | 1 | — |
| TiMn_{1.5}(V_{0.85}Fe_{0.15})_{0.4} | 32 | — | 55 | 11 | 2 | — |
| TiMn_{1.5}(V_{0.85}Fe_{0.15})_{0.4}Zr_{0.2} | 28 | — | 49 | 10 | 2 | 11 |
| TiMn_{1.5}(V_{0.85}Fe_{0.15})_{0.4}Zr_{0.3} | 29 | — | 49 | 5 | 1 | 16 |
| TiMn_{1.5}(V_{0.85}Fe_{0.15})_{0.4}Zr_{0.4} | 27 | — | 47 | 5 | 1 | 20 |

### Example 2—General Method: Characterisation of Hydrogen Storage Properties of Alloy Compositions

Hydrogen storage alloys in accordance with the present invention were tested to determine their hydrogen absorption properties. To measure the absorption-desorption kinetics and pressure-composition temperature (PCT), these materials were installed on an automated gas sorption instrument based on a Sievert apparatus principle. The material placed in a vessel is kept at constant temperature with the aid of a water bath kept at 10° C. Hydrogen absorption-desorption rates for all the alloys were measured at 30 to 1 bar of H₂ gas (99.999% purity) pressure, respectively. PCT measurements were carried out by providing small incremental doses of 2-5 bar H₂ gas pressure (increasing doses for absorption and decreasing doses for desorption). The hydrogen storage capacity of Ti_{1.1}CrMn- and TiMn_{1.5}-based alloys was determined up to 100 bar of H₂ gas pressure. (NOTE: A higher pressure is required for Ti_{1.1}CrMn to absorb hydrogen due to its high plateau pressure in comparison to TiMn_{1.5}).

### Example 3—Hydrogen Storage Properties of TiCrMn-based Alloys

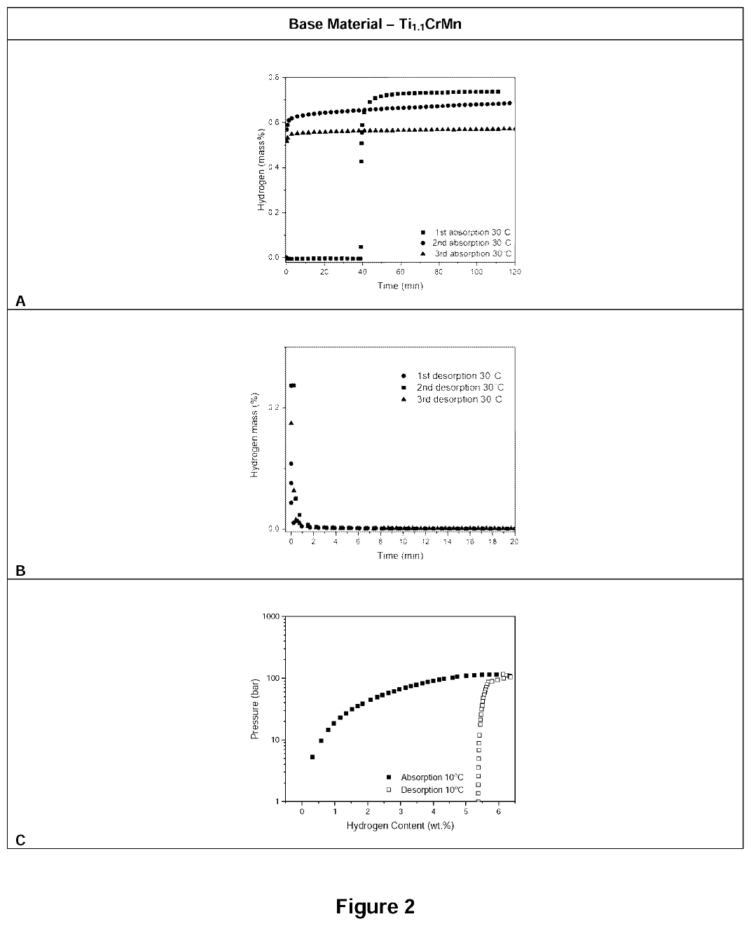

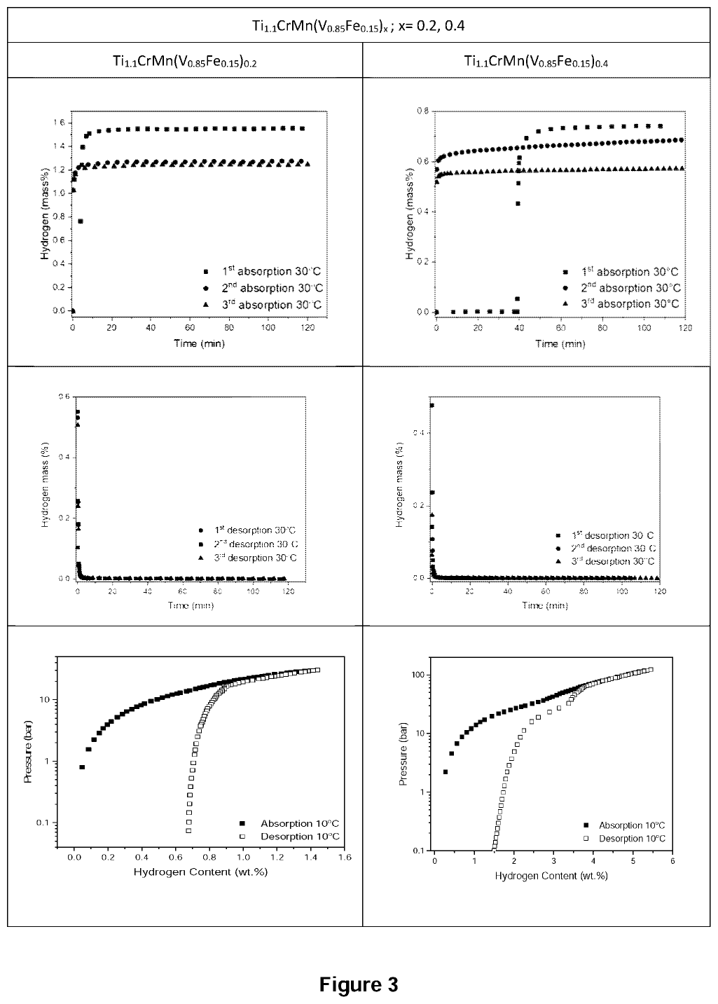

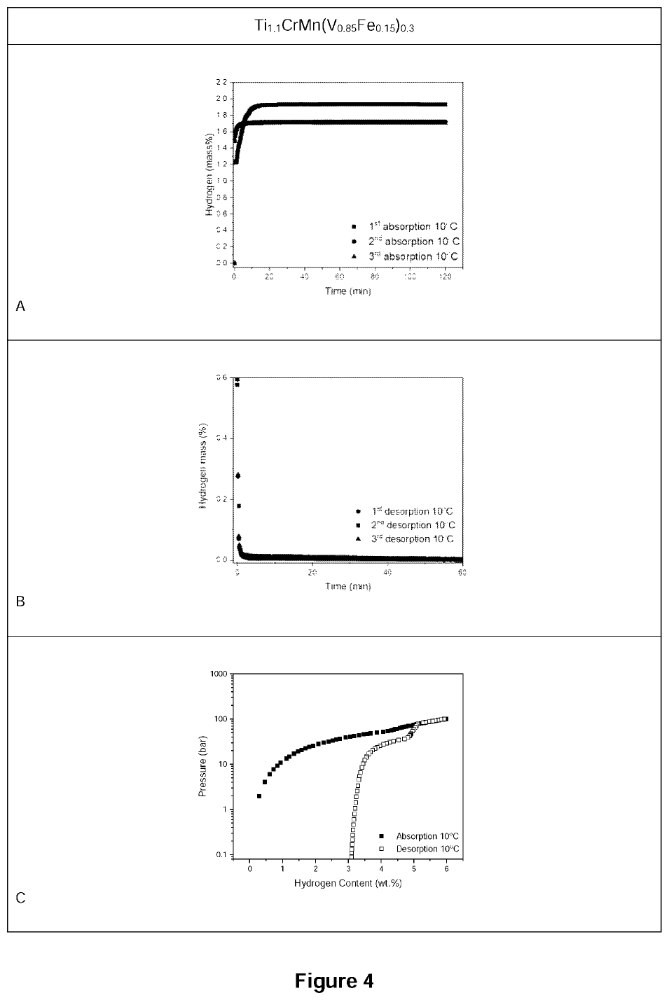

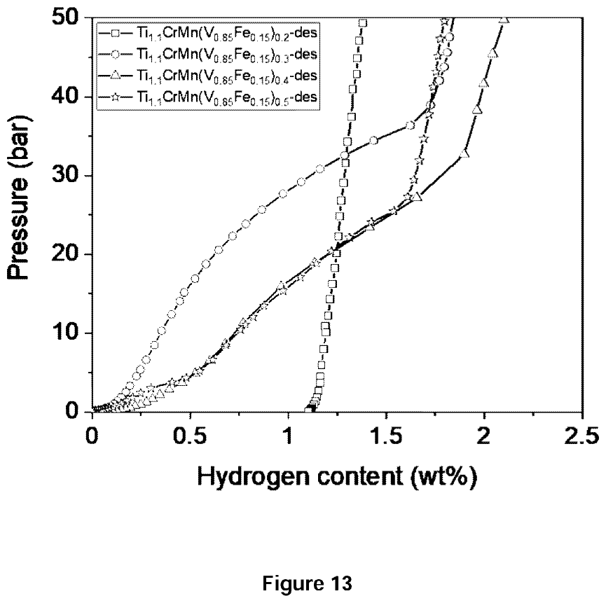

Table 2 summarises hydrogen storage (absorption/desorption) properties for exemplary TiCrMn-based alloy compositions. FIGS. 2-5 and FIGS. 13-15 show results for representative alloys.

TABLE 2

| | | | | H₂_{_{—}}ₘₐₓ | ΔH₂_{_{—}}ᵣₑᵥ | ³P_{eq}_{_{—}}_{Abs} | ⁴P_{eq}_{_{—}}_{Des} | |
|---|---|---|---|---|---|---|---|---|
| | | | | wt. % | wt. % | bar | bar | Time for |
| | | ¹Tₐₙₙₑₐₗ | ²Tₜₑₛₜ | @ 100-50 | @ 1 | @10° | @10° | sorption |
| | Alloy | ° C. | ° C. | bar | bar | C. | C. | min |
| | Ti_{1.1}CrMn | NA | 10 | 0.5 | 0.2 | 30 | — | |
| Increase | Ti_{1.1}CrMn(V_{0.85}Fe_{0.15})_{0.2} | NA | 10 | 1.4 | 0.8 | 30 | — | 3 |
| storage | Ti_{1.1}CrMn(V_{0.85}Fe_{0.15})_{0.3} | NA | 10 | 4.9 | 0.5 | 36 | 32 | |
| capacity | Ti_{1.1}CrMn(V_{0.85}Fe_{0.15})_{0.4} | NA | 10 | 4.6 | 2.0 | 30 | 25 | |
| | Ti_{1.1}CrMn(V_{0.85}Fe_{0.15})_{0.5} | NA | 10 | 4.0 | 2.0 | 20 | 20 | |
| Flat and | Ti_{1.1}Zr_{0.2}CrMn(V_{0.85}Fe_{0.15})_{0.4} | NA | 10 | 4.0 | 2.0 | 10 | 1 | |
| decrease | Ti_{1.1}Zr_{0.3}CrMn(V_{0.85}Fe_{0.15})_{0.4} | NA | 10 | 2.2 | 1.2 | 7 | 0.3 | |
| plateau | Ti_{1.1}Zr_{0.4}CrMn(V_{0.85}Fe_{0.15})_{0.4} | NA | 10 | 1.9 | 1.0 | <0.1 | <0.1 | |
| pressure | | | | | | | | |
| Decrease | Ti_{1.1}CrMn(V_{0.85}Fe_{0.15})_{0.5}V_{0.1} | NA | 10 | | 1.6 | 17 | 15, 3 | |
| plateau | Ti_{1.1}CrMn(V_{0.85}Fe_{0.15})_{0.5}V_{0.2} | NA | 10 | | 1.5 | 15 | 12, <1 | |
| pressure | Ti_{1.1}CrMn(V_{0.85}Fe_{0.15})_{0.5}V_{0.4} | NA | 10 | | 0.2 | — | — | |
| Increase | Ti_{1.1}CrMn(V_{0.85}Fe_{0.15})_{0.4}Fe_{0.05} | NA | 10 | | 1.8 | 32 | 27 | |
| plateau | Ti_{1.1}CrMn(V_{0.85}Fe_{0.15})_{0.4}Fe_{0.1} | NA | 10 | | 1.7 | 39 | 34 | |
| pressure | Ti_{1.1}CrMn(V_{0.85}Fe_{0.15})_{0.4}Fe_{0.2} | NA | 10 | | 2.0 | 70 | 60 | |
| Flat and | Ti_{1.1}Zr_{0.1}CrMn(V_{0.85}Fe_{0.15})_{0.4}Fe_{0.1} | NA | 10 | | 1.6 | 10 | — | |
| keep | Ti_{1.1}Zr_{0.2}CrMn(V_{0.85}Fe_{0.15})_{0.4}Fe_{0.2} | NA | 10 | | 1.1 | 3 | 2 | |
| plateau | TiZr_{0.1}CrMn(V_{0.85}Fe_{0.15})_{0.4}Fe_{0.05} | NA | 10 | | 1.6 | 9 | 8 | |
| pressure | TiZr_{0.1}CrMn(V_{0.85}Fe_{0.15})_{0.4}Fe_{0.1} | NA | 10 | | 1.7 | 13 | 12 | |
| Reduce | Ti_{1.1}CrMn(V_{0.85}Fe_{0.15})_{0.4}-900 | 900 | 10 | | 1.1 | 25 | 15 | |
| plateau | Ti_{1.1}CrMn(V_{0.85}Fe_{0.15})_{0.4}Zr_{0.2}Fe_{0.2}-900 | 900 | 10 | | 1.8 | 3.0 | 2 | |
| slope | Ti_{1.1}Zr_{0.3}CrMn(V_{0.85}Fe_{0.15})_{0.4}-900 | 900 | 10 | | 0.8 | 0.4 | <1 | |

¹Annealing temperature
²Temperature for hydrogen uptake and release test
³Absorption plateau pressure
⁴Desorption plateau pressure

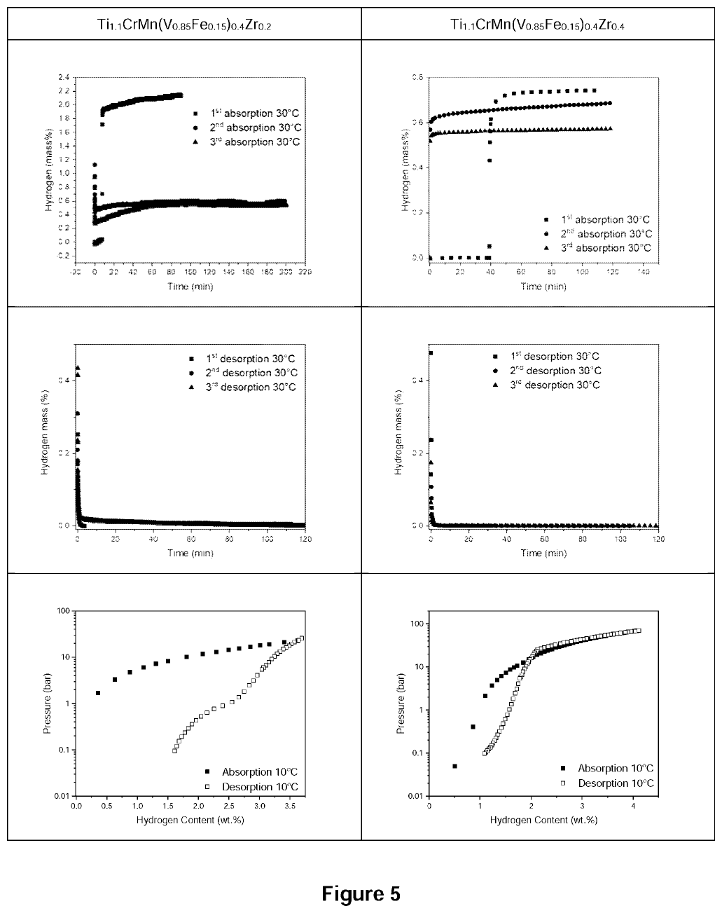

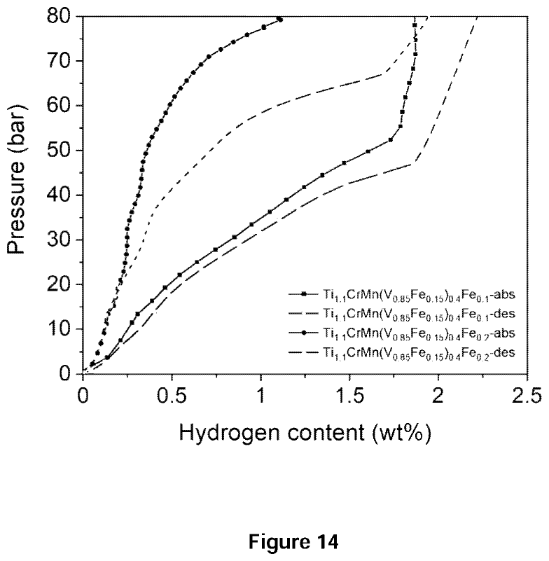

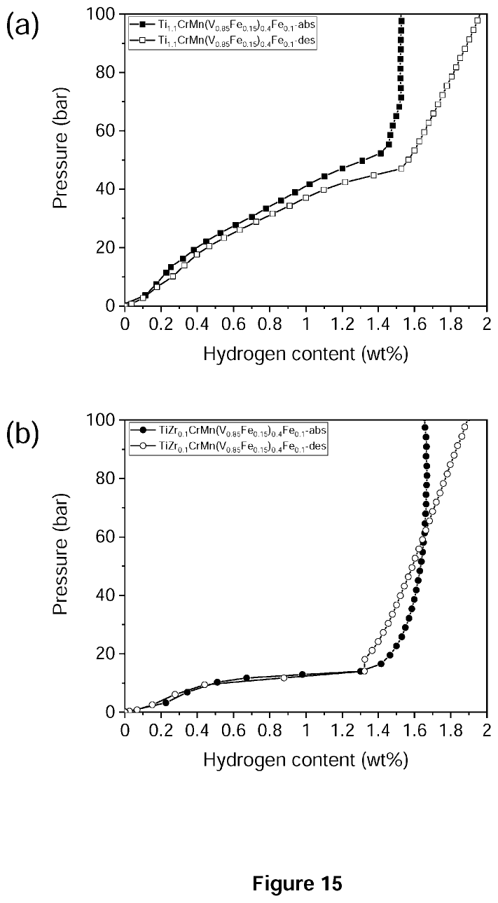

FIGS. 2-4 and FIG. 13 shows the effect of the addition of ferrovanadium (V_{0.85}Fe_{0.15}) in modifying the hydrogen storage capacity of TiCrMn-based alloys. The addition of ferrovanadium increases hydrogen storage capacity. FIG. 5 shows zirconium addition tunes the plateau pressure properties, e.g., decreases the hydrogen release/uptake pressure. FIG. 14 shows the effect of Fe on controlling the equilibrium plateau pressure of TiCrMn-based alloys. FIG. 15 shows the effect of partial substitution of Ti with Zr in controlling the plateau slope of TiCrMn-based alloys.

This example demonstrates the effect of the addition of various modifying elements to TiCrMn-based alloys, and annealing, on tuning hydrogen storage properties, including control of the slope of the plateau pressure by partial substitution of Ti with Zr, so the hydrogen storage properties of the alloy can be tuned to work within a certain temperature range.

These results demonstrate the effects of VFe (V_{0.85}Fe_{0.15}), V, Fe, Zr and Zr—Fe addition, for example in tuning the hydrogen storage properties of the alloy toward suitability for use in conjunction with electrolysers and fuel cells, and demonstrate the versatility of the present invention.

### Example 4— Hydrogen Storage Properties of TiCrMn-Based Alloys

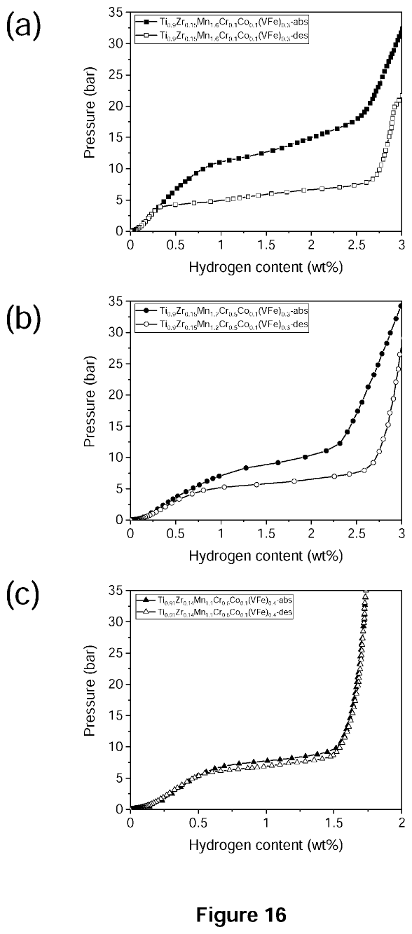

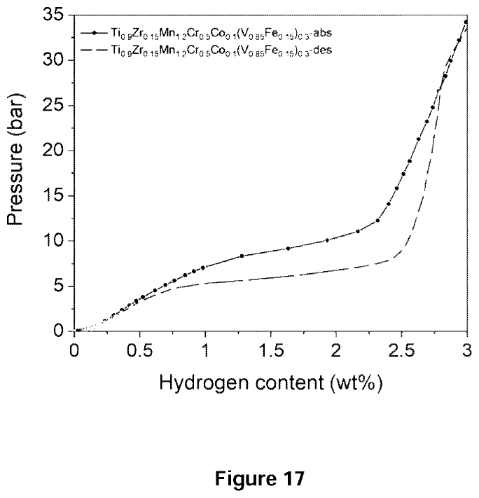

Table 3 provides a summary of the hydrogen storage properties of TiCrMn alloy compositions as a function of the tuning of hydrogen capacity, plateau pressure, plateau slope and hysteresis with elemental variations suitable for coupling with electrolysers and fuel cells. FIGS. 16 and 17 show the results for representative alloys.

TABLE 3

| | | | ΔH₂_{_{—}}ᵣₑᵥ | | |
|---|---|---|---|---|---|
| | Tₐₙₙₑₐₗ | Tₜₑₛₜ | wt. % | P_{eq}_{_{—}}_{Abs} | P_{eq}_{_{—}}_{Des} |
| Alloy | ° C. | ° C. | @ 1 bar | bar | bar |
| TiZr_{0.1}CrMn(V_{0.85}Fe_{0.15})_{0.4}Fe_{0.05} | NA | RT | 1.6 | 16 | 15 |
| TiZr_{0.1}CrMn(V_{0.85}Fe_{0.15})_{0.4}Fe_{0.06} | NA | RT | 1.6 | 17 | 15 |
| TiZr_{0.1}CrMn(V_{0.85}Fe_{0.15})_{0.4}Fe_{0.07} | NA | RT | 1.4 | 18 | 17 |
| TiZr_{0.1}CrMn(V_{0.85}Fe_{0.15})_{0.4}Fe_{0.09} | NA | RT | 1.3 | 19 | 18 |
| TiZr_{0.15}CrMn(V_{0.85}Fe_{0.15})_{0.4}Fe_{0.05} | NA | RT | 1.6 | 14 | 13 |
| TiZr_{0.2}CrMn(V_{0.85}Fe_{0.15})_{0.4}Fe_{0.05} | NA | RT | 1.6 | 4 | 3 |
| TiZr_{0.25}CrMn(V_{0.85}Fe_{0.15})_{0.4}Fe_{0.05} | NA | RT | 1.8 | 3 | 2 |
| (Ti_{0.65}Zr_{0.35})_{1.05}MnCr_{0.8}Fe_{0.2} | NA | RT | 1.7 | 2 | 1 |
| (Ti_{0.65}Zr_{0.35})_{1.05}MnCr_{0.75}(V_{0.85}Fe_{0.15})_{0.05}Fe_{0.2} | NA | RT | 1.9 | 2 | 1 |
| Ti_{0.9}Zr_{0.15}Mn_{1.6}Cr_{0.2}(V_{0.85}Fe_{0.15})_{0.25} | NA | RT | 1.8 | 13 | 5 |
| Ti_{0.9}Zr_{0.15}Mn_{1.6}Cr_{0.2}(V_{0.85}Fe_{0.15})_{0.3} | NA | RT | 1.9 | 9 | 4 |
| Ti_{0.9}Zr_{0.15}Mn_{1.6}Cr_{0.2}(V_{0.85}Fe_{0.15})_{0.35} | NA | RT | 1.8 | 10 | 5 |
| Ti_{0.9}Zr_{0.15}Mn_{1.6}Cr_{0.2}(V_{0.85}Fe_{0.15})_{0.4} | NA | RT | 1.9 | 9 | 5 |
| Ti_{0.9}Zr_{0.15}Mn_{1.6}Cr_{0.1}Co_{0.1}(V_{0.85}Fe_{0.15})_{0.3} | NA | RT | 2.8 | 14 | 6 |
| Ti_{0.9}Zr_{0.15}Mn_{1.6}Cr_{0.1}Fe_{0.1}(V_{0.85}Fe_{0.15})_{0.3} | NA | RT | 1.8 | 16 | 7 |
| Ti_{0.9}Zr_{0.15}Mn_{1.6}Cr_{0.1}Mo_{0.1}(V_{0.85}Fe_{0.15})_{0.3} | NA | RT | 1.7 | 8 | 5 |
| Ti_{0.9}Zr_{0.15}Mn_{1.5}Cr_{0.2}Co_{0.1}(V_{0.85}Fe_{0.15})_{0.3} | NA | RT | 1.9 | 12 | 6 |
| Ti_{0.9}Zr_{0.15}Mn_{1.4}Cr_{0.3}Co_{0.1}(V_{0.85}Fe_{0.15})_{0.3} | NA | RT | 1.8 | 11 | 7 |
| Ti_{0.9}Zr_{0.15}Mn_{1.3}Cr_{0.4}Co_{0.1}(V_{0.85}Fe_{0.15})_{0.3} | NA | RT | 1.8 | 10 | 6 |
| Ti_{0.9}Zr_{0.15}Mn_{1.2}Cr_{0.5}Co_{0.1}(V_{0.85}Fe_{0.15})_{0.3} | NA | RT | 2.8 | 9 | 6 |
| Ti_{0.9}Zr_{0.15}Mn_{1.1}Cr_{0.6}Co_{0.1}(V_{0.85}Fe_{0.15})_{0.3} | NA | RT | 1.8 | 8 | 7 |
| Ti_{0.9}Zr_{0.15}Mn_{1.6}Cr_{0.18}Mo_{0.02}(V_{0.85}Fe_{0.15})_{0.2} | NA | RT | 1.8 | 13 | 5 |
| Ti_{0.9}Zr_{0.15}Mn_{1.6}Cr_{0.15}Mo_{0.05}(V_{0.85}Fe_{0.15})_{0.2} | NA | RT | 1.8 | 11 | 5 |
| Ti_{0.9}Zr_{0.15}Mn_{1.6}Cr_{0.1}Mo_{0.1}(V_{0.85}Fe_{0.15})_{0.2} | NA | RT | 1.9 | 10 | 4 |
| Ti_{0.9}Zr_{0.15}Mn_{1.6}Cr_{0.15}Mo_{0.05}(V_{0.85}Fe_{0.15})_{0.4} | NA | RT | 1.7 | 8 | 5 |
| Ti_{0.9}Zr_{0.15}Mn_{1.6}Cr_{0.1}Mo_{0.1}(V_{0.85}Fe_{0.15})_{0.4} | NA | RT | 1.8 | 5.3 | 3.9 |
| Ti_{0.9}Zr_{0.15}Mn_{1.15}Cr_{0.5}Co_{0.1}Fe_{0.05}(V_{0.85}Fe_{0.15})_{0.3} | NA | RT | 1.9 | 10 | 7 |
| Ti_{0.9}Zr_{0.15}Mn_{1.1}Cr_{0.5}Co_{0.1}Fe_{0.1}(V_{0.85}Fe_{0.15})_{0.3} | NA | RT | 1.8 | 11 | 8 |
| Ti_{0.9}Zr_{0.15}Mn_{1.05}Cr_{0.5}Co_{0.1}Fe_{0.15}(V_{0.85}Fe_{0.15})_{0.3} | NA | RT | 1.7 | 12 | 9 |
| Ti_{0.9}Zr_{0.15}Mn_{1.1}Cr_{0.5}Co_{0.2}(V_{0.85}Fe_{0.15})_{0.3} | NA | RT | 1.7 | 12 | 9 |
| Ti_{0.9}Zr_{0.15}MnCr_{0.5}Co_{0.2}(V_{0.85}Fe_{0.15})_{0.4} | NA | RT | 1.8 | 6 | 5 |
| Ti_{0.9}Zr_{0.15}Mn_{0.9}Cr_{0.5}Co_{0.2}Mo_{0.1}(V_{0.85}Fe_{0.15})_{0.4} | NA | RT | 1.6 | 5 | 4 |
| Ti_{0.88}Zr_{0.17}Mn_{1.15}Cr_{0.5}Co_{0.1}Fe_{0.05}(V_{0.85}Fe_{0.15})_{0.3} | NA | RT | 1.7 | 8 | 6 |
| Ti_{0.9}Zr_{0.15}Mn_{1.18}Cr_{0.5}Co_{0.1}V_{0.02}(V_{0.85}Fe_{0.15})_{0.3} | NA | RT | 1.9 | 8 | 6 |
| TiZr_{0.1}Cr_{0.95}Mn(V_{0.85}Fe_{0.15})_{0.4}Fe_{0.05}Al_{0.05} | NA | 10 | 1.5 | 13 | 13 |
| Ti_{0.9}Zr_{0.15}Mn_{1.15}Cr_{0.5}Co_{0.1}V_{0.05}(V_{0.85}Fe_{0.15})_{0.3} | NA | RT | 1.8 | 6 | 5 |
| Ti_{0.9}Zr_{0.15}Mn_{1.1}Cr_{0.6}Co_{0.1}(V_{0.85}Fe_{0.15})_{0.35} | NA | RT | 1.7 | 8 | 7 |
| Ti_{0.9}Zr_{0.15}Mn_{1.1}Cr_{0.6}Co_{0.1}(V_{0.85}Fe_{0.15})_{0.4} | NA | RT | 1.9 | 6 | 5 |
| Ti_{0.91}Zr_{0.14}Mn_{1.1}Cr_{0.6}Co_{0.1}(V_{0.85}Fe_{0.15})_{0.4} | NA | RT | 1.7 | 8 | 7 |
| Ti_{0.9}Zr_{0.15}Mn_{1.05}Cr_{0.6}Co_{0.1}Fe_{0.05}(V_{0.85}Fe_{0.15})_{0.3} | NA | RT | 1.7 | 9 | 7 |
| Ti_{0.9}Zr_{0.15}Mn_{0.95}Cr_{0.6}Co_{0.1}Fe_{0.05}(V_{0.85}Fe_{0.15})_{0.4} | NA | RT | 1.7 | 5 | 5 |
| Ti_{0.9}Zr_{0.15}Mn_{1.05}Cr_{0.6}Co_{0.1}Fe_{0.05}(V_{0.85}Fe_{0.15})_{0.4} | NA | RT | 1.8 | 8 | 7 |
| Ti_{0.9}Zr_{0.1}Mn_{1.6}Cr_{0.2}(V_{0.85}Fe_{0.15})_{0.3} | NA | RT | 1.3 | 29 | — |

FIG. 16 shows the effect of Mn/Cr ratio in controlling the hysteresis of a TiCrMn-based alloy. This is an example of fine tuning to reduce the hysteresis, which can be brought down from e.g., ΔP=8 bar to ΔP=0.8 bar in the example shown in FIG. 16.

FIG. 17 shows Ti_{0.9}Zr_{0.15}Mn_{1.2}Cr_{0.5}Co_{0.1}(V_{0.85}Fe_{0.15})_{0.3} has high storage capacity and a plateau pressure which is suitable for hydrogen storage coupled with electrolyser and fuel cell. This is an example of a composition after fine tuning, which leads to a storage capacity of 2.8 wt % at 30 bar hydrogen pressure, a very narrow hysteresis of ΔP=3 bar, and flat plateau pressure.

These results demonstrate the ability to modify the alloy composition to tune hydrogen storage properties toward suitability for use in conjunction with electrolysers and fuel cells.

### Example 5— Hydrogen Storage Properties of TiMn-Based Alloys

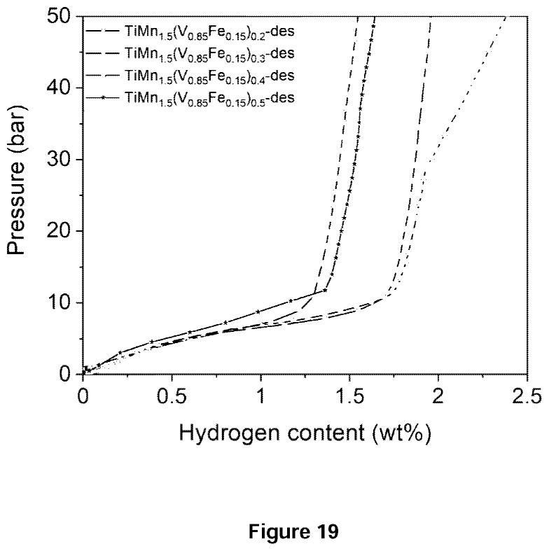

Table 4 summarises hydrogen storage properties of representative TiMn-based alloy compositions and demonstrates the effects of VFe (V_{0.85}Fe_{0.15}), V, Fe, Zr and Zr—Fe addition, for example in tuning the hydrogen storage properties of the alloy toward their use in conjunction with electrolysers and fuel cells, further demonstrating the versatility of the present invention. FIG. 19 shows the effect of ferrovanadium (V_{0.85}Fe_{0.15}) in controlling the hydrogen storage capacity of TiMn-based alloys. The addition of V_{0.85}Fe_{0.15} increased the storage capacity of the alloy.

TABLE 4

| | | | | H₂_{_{—}}ₘₐₓ | ΔH₂_{_{—}}ᵣₑᵥ | | | |
|---|---|---|---|---|---|---|---|---|
| | | | | wt. % | wt. % | | | Time for |
| | | Tₐₙₙₑₐₗ | Tₜₑₛₜ | @ 100-50 | @ 1 | P_{eq}_{_{—}}_{Abs} | P_{eq}_{_{—}}_{Des} | sorption |
| | Alloy | ° C. | ° C. | bar | bar | bar | bar | min |
| | TiMn_{1.5} | NA | 10 | 1.0 | 0.9 | 8 | 9 | 15 |
| Increase in | TiMn_{1.5}(V_{0.85}Fe_{0.15})_{0.2} | NA | 10 | 1.2 | 1.7 | 10 | 6 | 10 |
| storage | TiMn_{1.5}(V_{0.85}Fe_{0.15})_{0.3} | NA | 10 | 3.7 | 1.6 | 13 | 6 | 10 |
| capacity | TiMn_{1.5}(V_{0.85}Fe_{0.15})_{0.35} | NA | RT | — | 1.7 | 19 | 11 | 10 |
| | TiMn_{1.5}(V_{0.85}Fe_{0.15})_{0.4} | NA | 10 | 2.3 | 1.9 | 13 | 7 | 20 |
| | TiMn_{1.5}(V_{0.85}Fe_{0.15})_{0.5} | NA | 10 | 1.2 | 1.4 | 10 | 7 | 5 |
| Decrease | TiZr_{0.05}Mn_{1.5}(V_{0.85}Fe_{0.15})_{0.3} | NA | 10 | — | 1.7 | 5 | 3 | 5 |
| plateau | TiZr_{0.1}Mn_{1.5}(V_{0.85}Fe_{0.15})_{0.3} | NA | 10 | — | 1.6 | 2 | 1 | 5 |
| pressure | TiZr_{0.2}Mn_{1.5}(V_{0.85}Fe_{0.15})_{0.3} | NA | 10 | — | 0.5 | <0.1 | <0.1 | 3 |
| Decrease | TiMn_{1.5}(V_{0.85}Fe_{0.15})_{0.4} V_{0.1} | NA | 10 | — | 1.6 | 9 | 7 | 5 |
| plateau | TiMn_{1.5}(V_{0.85}Fe_{0.15})_{0.4} V_{0.2} | NA | 10 | — | 1.6 | 8 | 7 | 5 |
| pressure | TiMn_{1.5}(V_{0.85}Fe_{0.15})_{0.4} V_{0.4} | NA | 10 | — | 1.5 | 4 | 3 | 5 |
| Increase | TiMn_{1.5}(V_{0.85}Fe_{0.15})_{0.4}Fe_{0.2} | NA | 10 | — | 1.5 | 50 | 20 | 5 |
| plateau | TiMn_{1.5}(V_{0.85}Fe_{0.15})_{0.4}Fe_{0.1} | NA | 10 | — | 1.8 | 20 | 12 | 10 |
| pressure | TiMn_{1.5}(V_{0.85}Fe_{0.15})_{0.4}Fe_{0.05} | NA | 10 | — | 0.3 | — | — | 10 |

### Example 6—Hydrogen Storage Properties of TiMn-Based Alloys

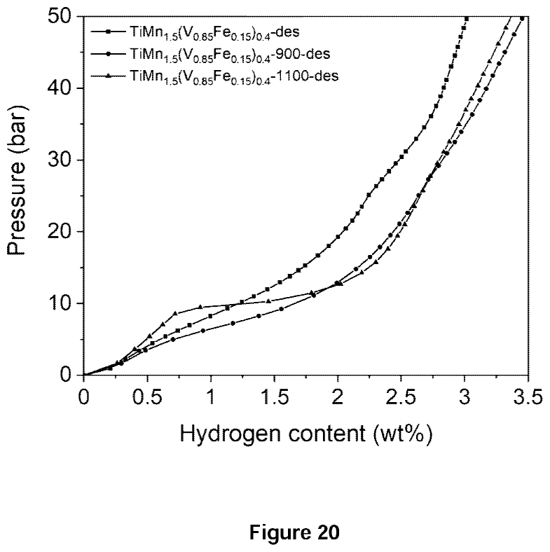

Table 5 summarises the hydrogen storage properties of TiMn-based alloy compositions as a function of the tuning of hydrogen capacity, plateau pressure, plateau slope and hysteresis with elemental variations for the coupling with electrolysers and fuel cells, further demonstrating the versatility of the present invention. FIGS. 20-22 show the results for representative alloys.

TABLE 5

| | | | ΔH₂_{_{—}}ᵣₑᵥ | | |
|---|---|---|---|---|---|
| | Tₐₙₙₑₐₗ | Tₜₑₛₜ | wt. % | P_{eq}_{_{—}}_{Abs} | P_{eq}_{_{—}}_{Des} |
| Alloy | ° C. | ° C. | @ 1 bar | bar | bar |
| TiMn_{1.5}-900 | 900 | 10 | 1.5 | 20 | 10 |
| TiMn_{1.5}(V_{0.85}Fe_{0.15})_{0.2}-900 | 900 | 10 | 1.5 | 10 | 5 |
| TiMn_{1.5}(V_{0.85}Fe_{0.15})_{0.3}-900 | 900 | 10 | 1.2 | 7 | 6 |
| TiMn_{1.5}(V_{0.85}Fe_{0.15})_{0.4}-900 | 900 | 10 | 2.0 | 10 | 5 |
| TiMn_{1.5}(V_{0.85}Fe_{0.15})_{0.5}-900 | 900 | 10 | 1.2 | 10 | 8 |
| TiMn_{1.5}(V_{0.85}Fe_{0.15})_{0.4}Zr_{0.05}-900 | 900 | 10 | 0.2 | — | — |
| TiMn_{1.5}(V_{0.85}Fe_{0.15})_{0.4}Zr_{0.1}-900 | 900 | 10 | 1.6 | 0.8 | 0.7 |
| TiMn_{1.5}(V_{0.85}Fe_{0.15})_{0.4}Zr_{0.2}-900 | 900 | 10 | 0.8 | 1 | 0.3 |
| TiMn_{1.5}(V_{0.85}Fe_{0.15})_{0.4}Fe_{0.2}-900 | 900 | 10 | 0.9 | 90 | 20 |
| TiMn_{1.5}(V_{0.85}Fe_{0.15})_{0.4}Fe_{0.1}-900 | 900 | 10 | 0.2 | — | — |
| TiMn_{1.5}(V_{0.85}Fe_{0.15})_{0.4}Fe_{0.05}-900 | 900 | 10 | 0.2 | — | — |
| TiMn_{1.5}(V_{0.85}Fe_{0.15})_{0.35}-1100 | 1100 | 10 | 1.7 | 10 | 6 |
| TiMn_{1.5}(V_{0.85}Fe_{0.15})_{0.4}-1100 | 1100 | 10 | 1.8 | 10 | 6 |
| TiMn_{1.5}(V_{0.85}Fe_{0.15})_{0.45}-1100 | 1100 | 10 | 3.0 | 10 | 6 |
| TiMn_{1.5}(V_{0.85}Fe_{0.15})_{0.5}-1100 | 1100 | 10 | 1.8 | 10 | 6 |
| TiMn_{1.5}(V_{0.85}Fe_{0.15})_{0.55}-1100 | 1100 | 10 | 1.8 | 10 | 7 |
| TiMn_{1.5}(V_{0.85}Fe_{0.15})_{0.6}-1100 | 1100 | 10 | 1.7 | 9 | 6 |
| TiMn_{1.48}V_{0.02}(V_{0.85}Fe_{0.15})_{0.4}-1100 | 1100 | RT | 1.6 | 13 | 8 |
| TiMn_{1.45}V_{0.05}(V_{0.85}Fe_{0.15})_{0.4}-1100 | 1100 | RT | 1.6 | 10 | 7 |
| TiMn_{1.4}V_{0.1}(V_{0.85}Fe_{0.15})_{0.4}-1100 | 1100 | RT | 1.7 | 6 | 5 |
| Ti_{0.95}Zr_{0.05}Mn_{1.5}(V_{0.85}Fe_{0.15})_{0.5}-1100 | 1100 | RT | 1.8 | 8 | 5 |
| Ti_{0.9}Zr_{0.1}Mn_{1.5}(V_{0.85}Fe_{0.15})_{0.5}-1100 | 1100 | RT | 1.7 | 4 | 3 |
| Ti_{0.85}Zr_{0.15}Mn_{1.5}(V_{0.85}Fe_{0.15})_{0.5}-1100 | 1100 | RT | 1.8 | 2 | 1 |
| Ti_{0.95}Zr_{0.05}Mn_{1.45}Fe_{0.05}(V_{0.85}Fe_{0.15})_{0.5}-1100 | 1100 | RT | 1.8 | 9 | 6 |
| TiMn_{1.45}Co_{0.05}(V_{0.85}Fe_{0.15})_{0.4}-1100 | 1100 | RT | 1.4 | — | — |
| TiMn_{1.4}Co_{0.1}(V_{0.85}Fe_{0.15})_{0.4}-1100 | 1100 | RT | 1.3 | 23 | 14 |
| TiMn_{1.35}Co_{0.15}(V_{0.85}Fe_{0.15})_{0.4}-1100 | 1100 | RT | 1.4 | 23 | 14 |
| Ti_{0.9}Mn_{1.5}(V_{0.85}Fe_{0.15})_{0.45}-1100 | 1100 | RT | 1.3 | 46 | 25 |
| Ti_{1.1}Mn_{1.5}(V_{0.85}Fe_{0.15})_{0.45}-1100 | 1100 | RT | 1.6 | 5 | 4 |
| Ti_{0.95}Zr_{0.05}Mn_{1.5}(V_{0.85}Fe_{0.15})_{0.45}-1100 | 1100 | RT | 1.7 | 8 | 6 |
| Ti_{0.9}Zr_{0.1}Mn_{1.5}(V_{0.85}Fe_{0.15})_{0.45}-1100 | 1100 | RT | 1.7 | 4 | 3 |
| Ti_{0.9}Zr_{0.1}Mn_{1.45}Fe_{0.05}(V_{0.85}Fe_{0.15})_{0.45}-1100 | 1100 | RT | 1.8 | 5 | 3 |
| Ti_{0.85}Zr_{0.15}Mn_{1.5}(V_{0.85}Fe_{0.15})_{0.45}-1100 | 1100 | RT | 1.74 | 2 | 1 |
| Ti_{0.85}Zr_{0.15}Mn_{1.45}Fe_{0.05}(V_{0.85}Fe_{0.15})_{0.45}-1100 | 1100 | RT | 1.88 | 2 | 2 |
| Ti_{0.8}Zr_{0.2}Mn_{1.5}(V_{0.85}Fe_{0.15})_{0.45}-1100 | 1100 | RT | 1.75 | 1 | 1 |
| Ti_{0.8}Zr_{0.2}Mn_{1.45}Fe_{0.05}(V_{0.85}Fe_{0.15})_{0.45}-1100 | 1100 | RT | 1.9 | 1 | 1 |

FIG. 20 shows the effect of the annealing process in controlling the plateau slope of TiMn-based alloys. Annealing treatment at temperatures higher than 900° C., preferably higher than 1000° C. were found to be effective means to reduce the plateau slope of TiMn-based alloys.

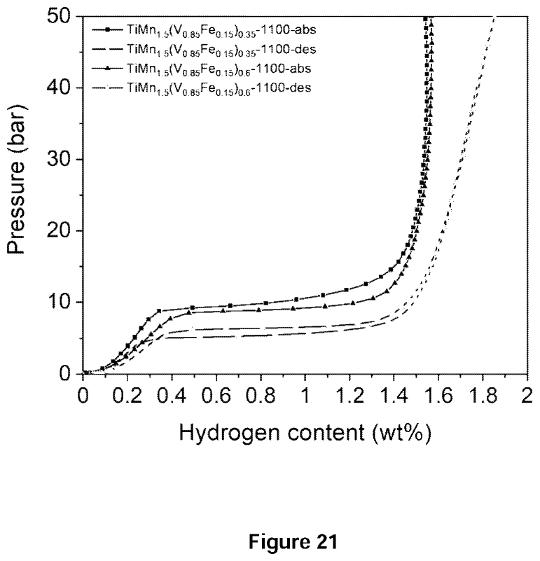

FIG. 21 shows the effect of the annealing process in controlling the hysteresis of TiMn-based alloys. The annealing process decreased the absorption plateau, while increasing the desorption plateau pressure, leading to a reduced hysteresis.

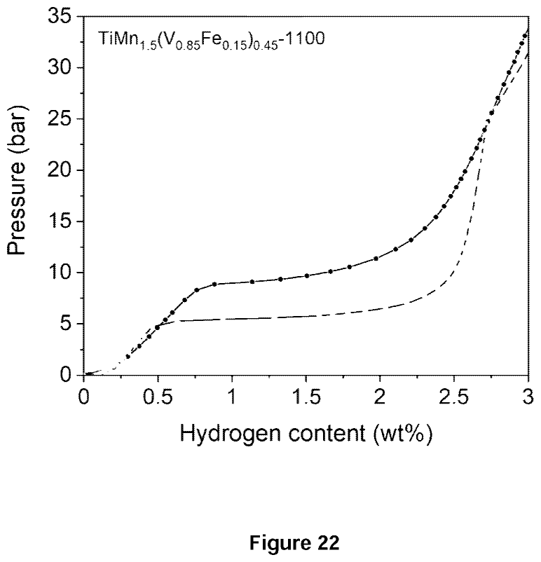

FIG. 22 shows TiMn_{1.5}(V_{0.85}Fe_{0.15})_{0.45} has a high storage capacity and suitable plateau pressure suitable for hydrogen storage coupled with electrolyser and fuel cell. This is an example of a composition after fine tuning, which led to an advantageous storage capacity of 2.9 wt % at 30 bar hydrogen pressure, a very narrow hysteresis of ΔP=4 bar, and flat plateau pressure.

### Example 7—XRD Analysis of TiCrMn-Based Alloy and TiMn-Based Alloy

Representative alloys obtained by arc-melting were characterized via X-Ray Diffraction (XRD) on a Philips X'pert Multipurpose XRD system operating at 45 kV and 40 mA with a monochromated Cu Kα radiation (λ=1.541 Å).

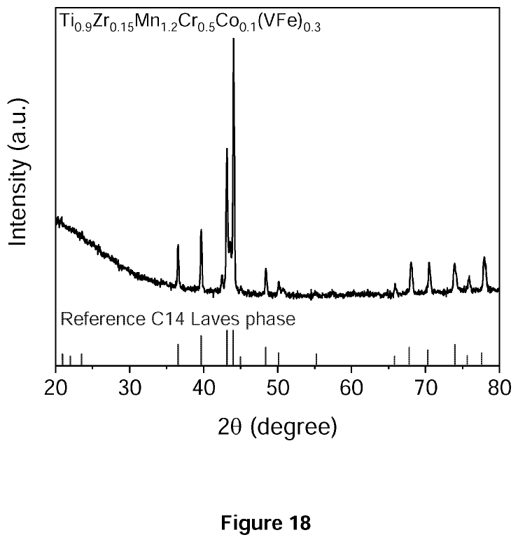

FIG. 18 shows the XRD pattern of Ti_{0.9}Zr_{0.15}Mn_{1.2}Cr_{0.5}Co_{0.1}(V_{0.85}Fe_{0.15})_{0.3} showing the C14 Laves phase of the alloy. This is a typical diffraction pattern of this new TiCrMn alloy family according to the present invention, and shows a preferred crystalline structure enabling hydrogen storage properties capable of meeting the requirement of fuel cells and electrolysers.

FIG. 23 shows the XRD pattern of TiMn_{1.5}(V_{0.85}Fe_{0.15})_{0.5} annealed at 1100° C. showing the C14 Laves phase of the alloy. This is a typical diffraction pattern of the new alloy TiMn family in accordance with the present invention.

### Example 8—Additional Hydrogen Properties

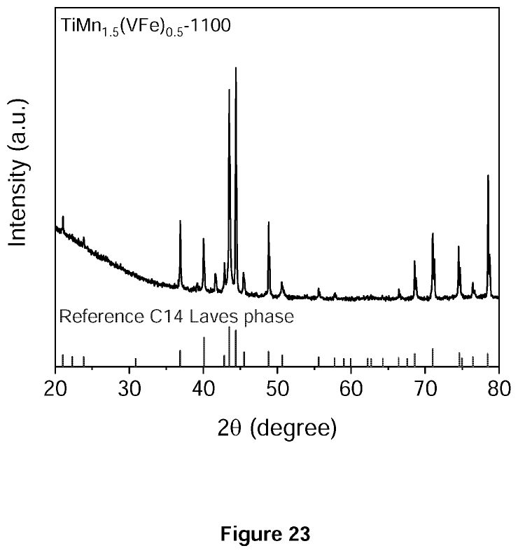

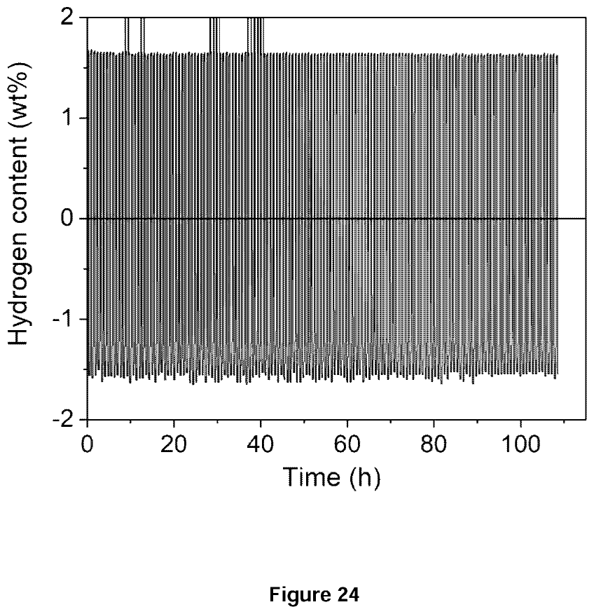

FIG. 24 shows cycling of the alloy Ti_{0.9}Zr_{0.15}Mn_{1.2}Cr_{0.5}Co_{0.1}(V_{0.85}Fe_{0.15})_{0.3} and advantageously demonstrates no degradation after 150 cycles. This is an example of long life cycling showing that the alloy is >90% efficient, does not lose its storage capacity and fully releases/absorbs hydrogen.

1. A hydrogen storage alloy having the formula TiₓZr_{y}Mn_{z}Crᵤ(V_{0.85}Fe_{0.15})ᵥM_{w}, wherein
M is selected from one or more of Fe, Co, Mo and Al;
x is 0.6-1.1;
y is 0-0.4;
z is 0.9-1.6;
u is 0-1;
v is 0.01-0.45;
w is 0-0.4.

2. The hydrogen storage alloy according to claim 1, wherein v is 0.02-0.6.

3. The hydrogen storage alloy according to claim 1, wherein v is 0.05, 0.1, 0.15, 0.2, 0.25, 0.3, 0.35, 0.4, 0.45, 0.50, 0.55 or 0.60.

4. The hydrogen storage alloy according to claim 1, wherein x is 0.9-1.1.

5. The hydrogen storage alloy according to claim 1, wherein y is 0.1-0.4.

6. The hydrogen storage alloy according to claim 1, wherein z is 1.0-1.6.

7. The hydrogen storage alloy according to claim 1, wherein z is 1.0, 1.05, 1.1, 1.15, 1.2, 1.25, 1.3, 1.35, 1.4, 1.45, 1.5, 1.55 or 1.6.

8. The hydrogen storage alloy according to claim 1, wherein u is 0, 0.1, 0.15, 0.18, 0.2, 0.3, 0.4, 0.5, 0.6, 0.75, 0.8 or 0.95.

9. The hydrogen storage alloy according to claim 1, wherein w is 0, 0.02, 0.05, 0.06, 0.07, 0.08, 0.09, 0.1, 0.2 or 0.4.

10. The hydrogen storage alloy according to claim 1, wherein the alloy is annealed at a temperature of from 900° C. to 1200° C.

11. A hydrogen storage alloy selected from:
Ti_{1.1}CrMn(V_{0.85}Fe_{0.15})_{0.2}, Ti_{1.1}CrMn(V_{0.85}Fe_{0.15})_{0.4}, Ti_{1.1}CrMn(V_{0.85}Fe_{0.15})_{0.4}Zr_{0.2}, Ti_{1.1}CrMn(V_{0.85}Fe_{0.15})_{0.4}Zr_{0.3}, TiMn_{1.5}(V_{0.85}Fe_{0.15})_{0.2}, TiMn_{1.5}(V_{0.85}Fe_{0.15})_{0.4}, TiMn_{1.5}(V_{0.85}Fe_{0.15})_{0.4}Zr_{0.2}, TiMn_{1.5}(V_{0.85}Fe_{0.15})_{0.4}Zr_{0.3}, Ti_{1.1}CrMn(V_{0.85}Fe_{0.15})_{0.2}, Ti_{1.1}CrMn(V_{0.85}Fe_{0.15})_{0.3}, Ti_{1.1}CrMn(V_{0.85}Fe_{0.15})_{0.4}, Ti_{1.1}CrMn(V_{0.85}Fe_{0.15})_{0.5}, Ti_{1.1}Zr_{0.2}CrMn(V_{0.85}Fe_{0.15})_{0.4}, Ti_{1.1}Zr_{0.3}CrMn(V_{0.85}Fe_{0.15})_{0.4}, Ti_{1.1} Zr_{0.4}CrMn(V_{0.85}Fe_{0.15})_{0.4}, Ti_{1.1}CrMn(V_{0.85}Fe_{0.15})_{0.5}V_{0.1}, Ti_{1.1}CrMn(V_{0.85}Fe_{0.15})_{0.5}V_{0.2}, Ti_{1.1}CrMn(V_{0.85}Fe_{0.15})_{0.15}V_{0.4}, Ti_{1.1}CrMn(V_{0.85}Fe_{0.15})_{0.4}Fe_{0.05}, Ti_{1.1}CrMn(V_{0.85}Fe_{0.15})_{0.4}Fe_{0.1}, Ti_{1.1}CrMn(V_{0.85}Fe_{0.15})_{0.4}Fe_{0.2}, Ti_{1.1}Zr_{0.1}CrMn(V_{0.85}Fe_{0.15})_{0.4}Fe_{0.1}, Ti_{1.1}Zr_{0.2}CrMn(V_{0.85}Fe_{0.15})_{0.4}Fe_{0.2}, TiZr_{0.1}CrMn(V_{0.85}Fe_{0.15})_{0.4}Fe_{0.05}, TiZr_{0.1}CrMn(V_{0.85}Fe_{0.15})_{0.4}Fe_{0.1}, Ti_{1.1}CrMn(V_{0.85}Fe_{0.15})_{0.4}-900, Ti_{1.1}CrMn(V_{0.85}Fe_{0.15})_{0.4}Zr_{0.2}Fe_{0.2}-900, Ti_{1.1}Zr_{0.3}CrMn(V_{0.85}Fe_{0.15})_{0.4}-900, TiZr_{0.1}CrMn(V_{0.85}Fe_{0.15})_{0.4}Fe_{0.05}, TiZr_{0.1}CrMn(V_{0.85}Fe_{0.15})_{0.4}Fe_{0.06}, TiZr_{0.1}CrMn(V_{0.85}Fe_{0.15})_{0.4}Fe_{0.07}, TiZr_{0.1}CrMn(V_{0.85}Fe_{0.15})_{0.4}Fe_{0.09}, TiZr_{0.15}CrMn(V_{0.85}Fe_{0.15})_{0.4}Fe_{0.05}, TiZr_{0.2}CrMn(V_{0.85}Fe_{0.15})_{0.4}Fe_{0.05}, TiZr_{0.25}CrMn(V_{0.85}Fe_{0.15})_{0.4}Fe_{0.05}, (Ti_{0.65}Zr_{0.35})_{1.05}MnCr_{0.75}(V_{0.85}Fe_{0.15})_{0.05}Fe_{0.2}, Ti_{0.9}Zr_{0.15}Mn_{1.6}Cr_{0.2}(V_{0.85}Fe_{0.15})_{0.25}, Ti_{0.9}Zr_{0.15}Mn_{1.6}Cr_{0.2}(V_{0.85}Fe_{0.15})_{0.3}, Ti_{0.9}Zr_{0.15}Mn_{1.6}Cr_{0.2}(V_{0.85}Fe_{0.15})_{0.35}, Ti_{0.9}Zr_{0.15}Mn_{1.6}Cr_{0.2}(V_{0.85}Fe_{0.15})_{0.4}, Ti_{0.9}Zr_{0.15}Mn_{1.6}Cr_{0.1}Co_{0.1}(V_{0.85}Fe_{0.15})_{0.3}, Ti_{0.9}Zr_{0.15}Mn_{1.6}Cr_{0.1}Fe_{0.1}(V_{0.85}Fe_{0.15})_{0.3}, Ti_{0.9}Zr_{0.15}Mn_{1.6}Cr_{0.1}Mo_{0.1}(V_{0.85}Fe_{0.15})_{0.3}, Ti_{0.9}Zr_{0.15}Mn_{1.5}Cr_{0.2}Co_{0.1}(V_{0.85}Fe_{0.15})_{0.3}, Ti_{0.9}Zr_{0.15}Mn_{1.4}Cr_{0.3}Co_{0.1}(V_{0.85}Fe_{0.15})_{0.3}, Ti_{0.9}Zr_{0.15}Mn_{1.3}Cr_{0.4}Co_{0.1}(V_{0.85}Fe_{0.15})_{0.3}, Ti_{0.9}Zr_{0.15}Mn_{1.2}Cr_{0.5}Co_{0.1}(V_{0.85}Fe_{0.15})_{0.3}, Ti_{0.9}Zr_{0.15}Mn_{1.1}Cr_{0.6}Co_{0.1}(V_{0.85}Fe_{0.15})_{0.3}, Ti_{0.9}Zr_{0.15}Mn_{1.6}Cr_{0.18}Mo_{0.02}(V_{0.85}Fe_{0.15})_{0.2}, Ti_{0.9}Zr_{0.15}Mn_{1.6}Cr_{0.5}Mo_{0.05}(V_{0.85}Fe_{0.15})_{0.2}, Ti_{0.9}Zr_{0.15}Mn_{1.6}Cr_{0.1}Mo_{0.1}(V_{0.85}Fe_{0.15})_{0.2}, Ti_{0.9}Zr_{0.15}Mn_{1.6}Cr_{0.5}Mo_{0.05}(V_{0.85}Fe_{0.15})_{0.4}, Ti_{0.9}Zr_{0.15}Mn_{1.6}Cr_{0.1}Mo_{0.1}(V_{0.85}Fe_{0.15})_{0.4}, Ti_{0.9}Zr_{0.15}Mn_{1.15}Cr_{0.5}Co_{0.1}Fe_{0.05}(V_{0.85}Fe_{0.15})_{0.3}, Ti_{0.9}Zr_{0.15}Mn_{1.1}Cr_{0.5}Co_{0.1}Fe_{0.1}(V_{0.85}Fe_{0.15})_{0.3}, Ti_{0.9}Zr_{0.15}Mn_{1.05}Cr_{0.5}Co_{0.1}Fe_{0.15}(V_{0.85}Fe_{0.15})_{0.3}, Ti_{0.9}Zr_{0.15}Mn_{1.1}Cr_{0.5}Co_{0.2}(V_{0.85}Fe_{0.15})_{0.3}, Ti_{0.9}Zr_{0.15}MnCr_{0.5}Co_{0.2}(V_{0.85}Fe_{0.15})_{0.4}, Ti_{0.9}Zr_{0.15}Mn_{0.9}Cr_{0.5}Co_{0.2}Mo_{0.1}(V_{0.85}Fe_{0.15})_{0.4}, Ti_{0.88}Zr_{0.17}Mn_{1.15}Cr_{0.5}Co_{0.1}Fe_{0.05}(V_{0.85}Fe_{0.15})_{0.3}, Ti_{0.9}Zr_{0.15}Mn_{1.18}Cr_{0.5}Co_{0.1}V_{0.02}(V_{0.85}Fe_{0.15})_{0.3}, TiZr_{0.1}Cr_{0.95}Mn(V_{0.85}Fe_{0.15})_{0.4}Fe_{0.05}Al_{0.05}, Ti_{0.9}Zr_{0.15}Mn_{1.15}Cr_{0.5}Co_{0.1}V_{0.05}(V_{0.85}Fe_{0.15})_{0.3}, Ti_{0.9}Zr_{0.15}Mn_{1.1}Cr_{0.6}Co_{0.1}(V_{0.85}Fe_{0.15})_{0.35}, Ti_{0.9}Zr_{0.15}Mn_{1.1}Cr_{0.6}Co_{0.1}(V_{0.85}Fe_{0.15})_{0.4}, Ti_{0.91}Zr_{0.14}Mn_{1.1}Cr_{0.6}Co_{0.1}(V_{0.85}Fe_{0.15})_{0.4}, Ti_{0.9}Zr_{0.15}Mn_{1.05}Cr_{0.6}Co_{0.1}Fe_{0.05}(V_{0.85}Fe_{0.15})_{0.3}, Ti_{0.9}Zr_{0.15}Mn_{0.95}Cr_{0.6}Co_{0.1}Fe_{0.05}(V_{0.85}Fe_{0.15})_{0.4}, Ti_{0.9}Zr_{0.15}Mn_{1.05}Cr_{0.6}Co_{0.1}Fe_{0.05}(V_{0.85}Fe_{0.15})_{0.4}, TiMn_{1.5}(V_{0.85}Fe_{0.15})_{0.2}, TiMn_{1.5}(V_{0.85}Fe_{0.15})_{0.3}, TiMn_{1.5}(V_{0.85}Fe_{0.15})_{0.35}, TiMn_{1.5}(V_{0.85}Fe_{0.15})_{0.4}, TiMn_{1.5}(V_{0.85}Fe_{0.15})_{0.5}, TiZr_{0.05}Mn_{1.5}(V_{0.85}Fe_{0.15})_{0.3}, TiZr_{0.1}Mn_{1.5}(V_{0.85}Fe_{0.15})_{0.3}, TiZr_{0.2}Mn_{1.5}(V_{0.85}Fe_{0.15})_{0.3}, TiMn_{1.5}(V_{0.85}Fe_{0.15})_{0.4} V_{0.1}, TiMn_{1.5}(V_{0.85}Fe_{0.15})_{0.4}V_{0.2}, TiMn_{1.5}(V_{0.85}Fe_{0.15})_{0.4}V_{0.4}, TiMn_{1.5}(V_{0.85}Fe_{0.15})_{0.4}Fe_{0.2}, TiMn_{1.5}(V_{0.85}Fe_{0.15})_{0.4}Fe_{0.1}, TiMn_{1.5}(V_{0.85}Fe_{0.15})_{0.2}-900, TiMn_{1.5}(V_{0.85}Fe_{0.15})_{0.3}-900, TiMn_{1.5}(V_{0.85}Fe_{0.15})_{0.4}-900, TiMn_{1.5}(V_{0.85}Fe_{0.15})_{0.5}-900, TiMn_{1.5}(V_{0.85}Fe_{0.15})_{0.4}Zr_{0.05}-900, TiMn_{1.5}(V_{0.85}Fe_{0.15})_{0.4}Zr_{0.1}-900, TiMn_{1.5}(V_{0.85}Fe_{0.15})_{0.4}Zr_{0.2}-900, TiMn_{1.5}(V_{0.85}Fe_{0.15})_{0.4}Fe_{0.2}-900, TiMn_{1.5}(V_{0.85}Fe_{0.15})_{0.4}Fe_{0.1}-900, TiMn_{1.5}(V_{0.85}Fe_{0.15})_{0.4}Fe_{0.05}-900, TiMn_{1.5}(V_{0.85}Fe_{0.15})_{0.35}-1100, TiMn_{1.5}(V_{0.85}Fe_{0.15})_{0.4}-1100, TiMn_{1.5}(V_{0.85}Fe_{0.15})_{0.45}-1100, TiMn_{1.5}(V_{0.85}Fe_{0.15})_{0.5}-1100, TiMn_{1.5}(V_{0.85}Fe_{0.15})_{0.55}-1100, TiMn_{1.5}(V_{0.85}Fe_{0.15})_{0.6}-1100, TiMn_{1.48}V_{0.02}(V_{0.85}Fe_{0.15})_{0.4}-1100, TiMn_{1.45}V_{0.05}(V_{0.85}Fe_{0.15})_{0.4}-1100, TiMn_{1.4}V_{0.1}(V_{0.85}Fe_{0.15})_{0.4}-1100, Ti_{0.95}Zr_{0.05}Mn_{1.5}(V_{0.85}Fe_{0.15})_{0.5}-1100, Ti_{0.9}Zr_{0.1}Mn_{1.5}(V_{0.85}Fe_{0.15})_{0.5}-1100, Ti_{0.85}Zr_{0.15}Mn_{1.5}(V_{0.85}Fe_{0.15})_{0.5}-1100, Ti_{0.95}Zr_{0.05}Mn_{1.45}Fe_{0.05}(V_{0.85}Fe_{0.15})_{0.5}-1100, TiMn_{1.45}Co_{0.05}(V_{0.85}Fe_{0.15})_{0.4}-1100, TiMn_{1.4}Co_{0.1}(V_{0.85}Fe_{0.15})_{0.4}-1100, TiMn_{1.35}Co_{0.15}(V_{0.85}Fe_{0.15})_{0.4}-1100, Ti_{0.9}Mn_{1.5}(V_{0.85}Fe_{0.15})_{0.45}-1100, Ti_{1.1}Mn_{1.5}(V_{0.85}Fe_{0.15})_{0.45}-1100, Ti_{0.95}Zr_{0.05}Mn_{1.5}(V_{0.85}Fe_{0.15})_{0.45}-1100, Ti_{0.9}Zr_{0.1}Mn_{1.5}(V_{0.85}Fe_{0.15})_{0.45}-1100, Ti_{0.9}Zr_{0.1}Mn_{1.45}Fe_{0.05}(V_{0.85}Fe_{0.15})_{0.45}-1100.

12. The hydrogen storage alloy according to claim 1, having a hydrogen storage capacity of 1.5 wt % H₂, or at least 1.6 wt % H₂, or at least 1.7 wt % H₂, at least 1.8 wt % H₂, or at least 1.9 wt % H₂, or at least 2.0 wt % H₂, or least 2.1 wt % H₂, or least 2.2 wt % H₂, or least 2.3 wt % H₂, or least 2.4 wt % H₂, or least 2.5 wt % H₂, or at least 2.6 wt % H₂, or at least 2.7 wt. % H₂, or at least 2.8 wt. % H₂, or at least 2.9 wt. % H₂, or least 3 wt % H₂, or least 3.25 wt % H₂, or least 3.5 wt % H₂, or least 3.75 wt % H₂, or at least 4 wt. % H₂ at 30 bar.

13. The hydrogen storage alloy according to claim 1, having a hydrogen storage capacity of at least 4.5 wt % H₂, or least 5 wt % H₂, or least 6 wt % H₂ at 100 bar.

14. The hydrogen storage alloy according to claim 12, wherein the temperature is 50° C. or less, 40° C. or less, 30° C. or less, 20° C. or less, or 10° C. or less.

15. The hydrogen storage alloy according to claim 1, which is adapted to desorb at least 65%, or at least 75%, at least 80%, or at least 85%, or at least 90%, or at least 95% of the stored hydrogen at 30 bar.

16. The hydrogen storage alloy according to claim 1, capable of a rate of uptake and release of hydrogen of at least about 0.5 g H₂/min, or at least about 0.75 g H₂/min, or at least about 1.0 g H₂/min, or at least about 1.25 g H₂/min, or at least about 1.4 g H₂/min.

17. The hydrogen storage alloy according to claim 1, having a C14 Laves phase structure.

18. Use of an alloy according to claim 1, for the storage and release of hydrogen.

19. The hydrogen storage alloy according to claim 13, wherein the temperature is 50° C. or less, 40° C. or less, 30° C. or less, 20° C. or less, or 10° C. or less.
